(19) United States
(12) Patent Application Publication
(10) Pub. No.: US 2026/0223012 A1
(43) Pub. Date: Jul. 30, 2026

(54) USER EQUIPMENT, BASE STATION, AND METHOD FOR STxMP OPERATION

(71) Applicant: SHARP KABUSHIKI KAISHA, Sakai City, Osaka (JP)

(72) Inventors: CHIA-HUNG LIN, Taipei (TW); MEI-JU SHIH, Taipei (TW)

(21) Appl. No.: 19/143,558

(22) PCT Filed: Dec. 29, 2023
(86) PCT No.: PCT/CN2023/143444

§ 371 Date: Jun. 26, 2025

Related U.S. Application Data
(60) Provisional application No. 63/436,415, filed on Dec. 30, 2022.

(51) Int. Cl. H04W 52/36; H04B 7/06; H04L 5/00; H04W 52/24; H04W 76/20

(52) U.S. Cl. CPC H04W 52/365; H04B 7/06968; H04L 5/0051; H04W 52/242; H04W 52/367; H04W 76/20

(57) ABSTRACT

A method performed by a user equipment (UE) for simultaneous transmission with multi-panel (STxMP) operation is provided. The method includes receiving a first Radio Resource Control (RRC) parameter from a base station (BS) for indicating STxMP based physical uplink shared channel (PUSCH) transmission; receiving, from the BS, a first Transmission Configuration Indication (TCI) state indication, a second TCI state indication, a first Sounding Reference Signal (SRS) resource set, and a second SRS resource set; performing a first PUSCH transmission associated with the first SRS resource set and a second PUSCH transmission associated with the second SRS resource set simultaneously; receiving, from the BS, a second RRC parameter that indicates to the UE to provide two Type-1 power headroom (PH) reports; and transmitting, to the BS, a power headroom report (PHR) medium access control (MAC) control element (CE) including a first Type-1 PH and a second Type-1 PH.

### FIELD

The present disclosure is related to wireless communication and, more specifically, to user equipment (UE), base station (BS), and method for a simultaneous transmission with multi-panel (STxMP) operation in cellular wireless communication networks.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a UE, a BS, and a method for an STxMP operation in cellular wireless communication networks.

In a first aspect of the present application, a method performed by a UE for STxMP operation is provided. The method includes receiving a first Radio Resource Control (RRC) parameter from a base station (BS), the first RRC parameter indicating to the UE to perform STxMP based physical uplink shared channel (PUSCH) transmission, the first RRC parameter further indicating one of a Single-Frequency Network (SFN) scheme or a Spatial Division Multiplexing (SDM) scheme for the STxMP based PUSCH transmission; receiving, from the BS, a first Transmission Configuration Indication (TCI) state indication, a second TCI state indication, a first Sounding Reference Signal (SRS) resource set, and a second SRS resource set; performing a first PUSCH transmission associated with the first SRS resource set and a second PUSCH transmission associated with the second SRS resource set simultaneously; receiving, from the BS, a second RRC parameter that indicates to the UE to provide two Type-1 power headroom (PH) reports, including a first Type-1 PH corresponding to the first PUSCH transmission and a second Type-1 PH corresponding to the second PUSCH transmission; and transmitting, to the BS, a power headroom report (PHR) medium access control (MAC) control element (CE) including the first Type-1 PH and the second Type-1 PH. The first SRS resource set and the second SRS resource set are associated with a serving cell of the BS, the first TCI state indication is applied to the first PUSCH transmission, the second TCI state indication is applied to the second PUSCH transmission, the first Type-1 PH is based on a first pathloss reference signal (RS) associated with the first TCI state indication, and the second Type-1 PH is based on a second pathloss RS associated with the second TCI state indication.

In an implementation of the first aspect, the PHR MAC CE further includes a first maximum uplink transmit power associated with the first PUSCH transmission and a second maximum uplink transmit power associated with the second PUSCH transmission. The first Type-1 PH is further based on the first maximum uplink transmit power, and the second Type-1 PH is further based on the second maximum uplink transmit power.

In another implementation of the first aspect, the method further includes receiving a third RRC parameter that indicates a power change threshold for triggering PHR for the STxMP based PUSCH transmission. The power change threshold is associated with both the first PUSCH transmission and the second PUSCH transmission.

In another implementation of the first aspect, the PHR for the STxMP based PUSCH transmission is triggered in a case that either a first path loss associated with the first PUSCH transmission or a second path loss associated with the PUSCH transmission has changed more than the power change threshold.

In another implementation of the first aspect, a first number of transmission layers associated with the first PUSCH transmission is equal to a second number of transmission layers associated with the second PUSCH transmission in a case that the first RRC parameter indicates the SFN scheme for the STxMP based PUSCH transmission.

In a second aspect of the present application, a UE for STxMP operation is provided. The UE includes one or more processors and at least one memory coupled to at least one of the one or more processors. The at least one memory stores computer-executable instructions that, when executed by the at least one of the one or more processors, cause the UE to: receive a first RRC parameter from a BS, the first RRC parameter indicating to the UE to perform STxMP based PUSCH transmission, the first RRC parameter further indicating one of an SFN scheme or an SDM scheme for the STxMP based PUSCH transmission; receive, from the BS, a first TCI state indication, a second TCI state indication, a first SRS resource set, and a second SRS resource set; perform a first PUSCH transmission associated with the first SRS resource set and a second PUSCH transmission associated with the second SRS resource set simultaneously; receive, from the BS, a second RRC parameter that indicates to the UE to provide two Type-1 PH reports, including a first Type-1 PH corresponding to the first PUSCH transmission and a second Type-1 PH corresponding to the second PUSCH transmission; and transmit, to the BS, a PHR MAC CE including the first Type-1 PH and the second Type-1 PH. The first SRS resource set and the second SRS resource set are associated with a serving cell of the BS, the first TCI state indication is applied to the first PUSCH transmission, the second TCI state indication is applied to the second PUSCH transmission, the first Type-1 PH is based on a first pathloss RS associated with the first TCI state indication, and the second Type-1 PH is based on a second pathloss RS associated with the second TCI state indication.

In a third aspect of the present application, a BS for configuring STxMP operation is provided. The BS includes one or more processors and at least one memory coupled to at least one of the one or more processors. The at least one memory stores computer-executable instructions that, when executed by the at least one of the one or more processors, cause the BS to: transmit a first RRC parameter to a UE, the first RRC parameter indicating to the UE to perform STxMP based PUSCH transmission, the first RRC parameter further indicating one of an SFN scheme or an SDM scheme for the STxMP based PUSCH transmission; transmit, to the UE, a first TCI state indication, a second TCI state indication, a first SRS resource set, and a second SRS resource set, which enable the UE to perform a first PUSCH transmission associated with the first SRS resource set and a second PUSCH transmission associated with the second SRS resource set simultaneously; transmit, to the UE, a second RRC parameter that indicates to the UE to provide two Type-1 PH reports, including a first Type-1 PH corresponding to the first PUSCH transmission and a second Type-1 PH corresponding to the second PUSCH transmission; and receive, from the UE, a PHR MAC CE including the first Type-1 PH and the second Type-1 PH. The first SRS resource set and the second SRS resource set are associated with a serving cell of the BS, the first TCI state indication is applied to the first PUSCH transmission, the second TCI state indication is applied to the second PUSCH transmission, the first Type-1 PH is based on a first pathloss RS associated with the first TCI state indication, and the second Type-1 PH is based on a second pathloss RS associated with the second TCI state indication.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 illustrates a TRP-specific power control for STxMP operation according to an example implementation of the present disclosure.

FIG. 2 illustrates a single entry PHR MAC CE for the STxMP based PUSCH transmission according to an example implementation of the present disclosure.

FIG. 3 illustrates a multiple entry PHR MAC CE for the STxMP based PUSCH transmission according to an example implementation of the present disclosure.

FIG. 4 is a flowchart illustrating a method/process for STxMP operation performed by a UE, according to an example implementation of the present disclosure.

FIG. 5 is a flowchart illustrating a method/process for STxMP operation performed by a BS, according to an example implementation of the present disclosure.

FIG. 6 is a block diagram illustrating a node for wireless communication, according to an example implementation of the present disclosure.

### DESCRIPTION

Some abbreviations used in the present disclosure include:

| Abbreviation | Full name |
|---|---|
| 3GPP | 3^{rd} Generation Partnership Project |
| 5G | 5^{th} Generation |
| ACK | Acknowledgment |
| BS | Base Station |
| BWP | Bandwidth Part |
| C-RNTI | Cell Radio Network Temporary Identifier |
| CA | Carrier Aggregation |
| CB | Codebook |
| CC | Component Carrier |
| CG | Configured Grant |
| CPE | Customer Premises Equipment |
| CRC | Cyclic Redundancy Check |
| CS-RNTI | Configured Scheduling Radio Network Temporary |
| | Identifier |
| CSI-RS | Channel State Information Reference Signal |
| DC | Dual Connectivity |
| DCI | Downlink Control Information |
| DL | Downlink |
| DM-RS | Demodulation Reference Signal |
| E-UTRA | Evolved Universal Terrestrial Radio Access |
| FR | Frequency Range |
| FWA | Fixed Wireless Access |
| HARQ | Hybrid Automatic Repeat Request |
| HARQ-ACK | HARQ Acknowledgement |
| ID | Identifier |
| IE | Information Element |
| LTE | Long Term Evolution |
| MAC | Medium Access Control |
| MAC CE | MAC Control Element |
| MCG | Master Cell Group |
| MCS | Modulation Coding Scheme |
| MN | Master Node |
| MPE | Maximum Permissible Exposure |
| NAS | Non Access Stratum |
| NR | New Radio |
| NW | Network |
| NZP | Non-Zero Power |
| OFDM | Orthogonal Frequency Division Multiplexing |
| PCell | Primary Cell |
| PDCCH | Physical Downlink Control Channel |
| PDSCH | Physical Downlink Shared Channel |
| PH | Power Headroom |
| PHR | Power Headroom Report |
| PHY | Physical (layer) |
| P-MPR | Power Management Maximum Power Recution |
| PRACH | Physical Random Access Channel |
| PUCCH | Physical Uplink Control Channel |
| PUSCH | Physical Uplink Shared Channel |
| QCL | Quasi-colocation |
| RA | Random Access |
| RAN | Radio Access Network |
| Rel | Release |
| RI | Rank Indicator |
| RF | Radio Frequency |
| RNTI | Radio Network Temporary Identifier |
| RRC | Radio Resource Control |
| RRH | Remote Radio Head |
| RS | Reference Signal |
| SCell | Secondary Cell |
| SCG | Secondary Cell Group |
| SDM | Spatial Division Multiplexing |
| SFN | Single-Frequency Network |
| SN | Secondary Node |
| SRI | SRS Resource Indicator |
| SRS | Sounding Reference Signal |
| STxMP | Simultaneous Transmission with Multi-Panel |
| TB | Transport Block |
| TCI | Transmission Configuration Indicator |
| TDM | Time-Division Multiplexing |
| TPC | Transmission Power Control |
| TPMI | Transmit Precoding Matrix Indicator |
| TRI | Transmission Rank Indication |
| TRP | Transmission Reception Point |
| TS | Technical Specification |
| Tx | Transmission |
| UE | User Equipment |
| UL | Uplink |
| URLLC | Ultra-Reliable and Low-Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

It should be noted that the term ‘TRP’ in the present disclosure may be replaced by ‘beam’ or ‘panel’. It should be noted that the term ‘overlap’ may refer to time domain overlapping.

Examples of some selected terms in the present disclosure are provided as follows.

Antenna Panel: is a conceptual term for UE antenna implementation. It may be assumed that a panel is an operational unit for controlling a transmission spatial filter (beam). A panel is typically consisted of a plurality of antenna elements. In one implementation, a beam may be formed by a panel and in order to form two beams simultaneously, two panels may be needed. Such simultaneous beamforming from multiple panels is subject to UE capability. A similar definition for “panel” may be possible by applying spatial receiving filtering characteristics.

Beam: the terms “beam” and “spatial filter” may be used interchangeably in the present disclosure. For example, when a UE reports a preferred gNB Tx beam, the UE is essentially selecting a spatial filter used by the gNB. The term “beam information” is used to provide information about which beam/spatial filter is being used/selected. In some implementations, individual reference signals are transmitted by applying individual beams (spatial filters). Thus, the term “beam” or “beam information” may be represented by reference signal resource index(es).

DCI: DCI stands for downlink control information and there are various DCI formats used in the PDCCH. The DCI format is a predefined format in which the downlink control information is packed/formed and transmitted in the PDCCH.

TCI state: a TCI state contains parameters for configuring a QCL relationship between one or two reference signals and a target reference signal set. For example, a target reference signal set may be the DM-RS ports of the PDSCH, PDCCH, PUCCH or PUSCH.

HARQ: is a functionality that ensures delivery between peer entities at Layer 1 (e.g., PHY Layer). A single HARQ process may support one TB when the PHY layer is not configured for DL/UL spatial multiplexing. A single HARQ process may support one or multiple TBs when the PHY layer is configured for DL/UL spatial multiplexing. There may be one HARQ entity per serving cell. Each HARQ entity may support parallel processing of (e.g., multiple) DL and UL HARQ processes.

In 3GPP RAN#94-e meeting, STxMP has been approved to study in Rel-18 NR. The details for studying are given as below:

Study, and if needed, specify the following items to facilitate simultaneous multi-panel UL transmission for higher UL throughput/reliability, focusing on FR2 and multi-TRP, assuming up to 2 TRPs and up to 2 panels, targeting CPE/FWA/vehicle/industrial devices (if applicable).
UL precoding indication for PUSCH, where no new codebook is introduced for multi-panel simultaneous transmission. The total number of layers is up to four across all panels and the total number of codewords is up to two across all panels, considering single DCI and multi-DCI based multi-TRP operation.
UL beam indication for PUCCH/PUSCH, where unified TCI framework extension in objective 2 is assumed, considering single DCI and multi-DCI based multi-TRP operation. For the case of multi-DCI based multi-TRP operation, only PUSCH+PUSCH, or PUCCH+PUCCH is transmitted across two panels in a same CC.

Different from the single-TRP based operation, STxMP may allow a UE to transmit UL signal toward multiple TRPs/gNBs located at different geographic areas at the same time-frequency resources. Therefore, TRP specific signaling (e.g., TRP specific beam management, TRP specific power control) may be needed for STxMP operation to provide better system throughput and transmission reliability. In the present disclosure, the proposed design aims to enhance UL transmissions with the STxMP operation.

In Rel-16 NR, multi-TRP based PDSCH repetition may be applied for URLLC purposes. The reliability of PDSCH transmission under multi-TRP scenario may be enhanced by PDSCH repetition. Based on the development of PDSCH enhancement in multi-TRP, the enhancement of other physical channels (e.g., PUSCH, PDCCH, and/or PUCCH) may be achieved via multi-TRP operation.

For PUSCH, two types of transmission modes may be supported in NR, namely CB based (e.g., the higher layer parameter txConfig in pusch-Config is set to ‘codebook’) and non-CB based (e.g., the higher layer parameter txConfig in pusch-Config is set to ‘non-codebook’) transmission. Basically, the operation of CB-based UL transmission depends on the NW indications on transmission parameters. For example, TRI, beam information, TCI states, and/or TPMI may be frequently adopted as signaling content. TRI, beam information, TCI states, and/or TPMI may be associated with a set of SRSs and/or each SRS configured in an SRS resource set. The transmission parameters may be TPMI, SRI, transmission beam information, TCI states, and/or power control parameters (e.g., TPC, pathloss RS, α₀). The TCI states may be DL TCI states, UL TCI states, and/or joint TCI states. In short, for CB based UL transmission, the transmission precoder and the corresponding transmission layer may be indicated by the NW via a DCI field (e.g., TPMI field). Similarly, the transmission beam and the corresponding transmission rank may be indicated by the NW via a DCI field (e.g., SRI field).

Different from CB-based UL transmission, for non-CB based UL transmission, the UE may determine its transmission precoder and the corresponding transmission rank/layer based on SRI. SRI may be given by DCI or a higher layer parameter (e.g., srs-ResourceIndicator). In order to train the transmission precoder for the corresponding UL transmission, an SRS resource set whose usage is set to “noncodebook” may be configured to the UE via RRC signaling/message. A UE may transmit some candidate precoders to the gNB by non-CB SRS resource transmission. In addition, the UE may derive the candidate precoders based on DL measurements on an associated NZP CSI-RS. The SRS resource set with usage set to “noncodebook” may be associated with one or more NZP CSI-RS.

No matter CB or Non-CB based UL transmission is configured to a UE by the gNB, UL power control is needed. To provide a precise and effective UL power control indication, the gNB may acquire the PHR transmitted by a device/UE. The PHR may be used to indicate the remaining transmission power that a UE can use except the power used for the current data transmission. In addition, the PHR may be used to assist the NW to decide the UL transmission parameters (e.g., MCS) for the upcoming UL transmission (e.g., PUSCH transmission, SRS transmission).

Not only single TRP based UL transmission but also multi-TRP based UL transmission may require transmission of the PHR to the gNB. Therefore, the gNB may decide/determine the transmission parameters for the corresponding single TRP/multi-TRP based UL transmission.

Different from the PHR used for the single TRP based UL transmission, the PHR used for the multi-TPR based UL transmission may include two PHs in a PHR, where each PH may be associated with one or more TRP(s), SRS resource set(s) and/or TCI state(s). That is, TRP-specific power control may be applied for multi-TRP UL transmission. TCI state(s) may be UL TCI state(s), DL TCI state(s), and/or joint TCI state(s). Like multi-TRP based UL transmission, the UE may transmit a PHR including two PHs when being instructed to perform STxMP operation by the gNB. It should be noted that two PHs included in a PHR transmitted by a single entry PHR MAC CE may correspond to a serving cell in the present disclosure. The two PHs in the PHR may include a first Type-1 PH and a second Type-1 PH. For example, four categories of PHs may be identified in NR for providing different information to a serving gNB, where the Type-1 PH is used to provide the difference between the nominal UE maximum transmit power and the estimated power for PUSCH transmission per activated serving cell.

For STxMP based operation, a UE may receive one or two beam indications, from a gNB/NW, for UL signal transmissions toward one or two TRPs. The UL signals may be transmitted by one or two beams indicated by the gNB/NW. The one or two beams may be transmitted by the one or two panels. It should be noted that the UL signal transmissions may refer to UL signaling transmission and/or UL data transmission.

In some implementations, a UE may receive one beam indication, from a gNB/NW, for two UL signal transmissions toward two TRPs. The beam indicated by the gNB/NW may be transmitted by one or two panels.

In some implementations, a UE may receive two beam indications, from a gNB/NW, for two UL signal transmissions toward one TRP. Each beam indicated by the gNB/NW may be transmitted by one or two panels.

It should be noted that a UE may be configured with one or two beams to transmit two UL transmissions toward one or two TRPs by one or two panels for STxMP based UL transmission (e.g., PUSCH transmission, PUCCH transmission or SRS transmission).

For the UL transmission with STxMP operation, the UE may transmit two UL transmissions (e.g., PUSCH transmissions, PUCCH transmissions, and/or SRS transmissions) toward two TRPs respectively at the same time-frequency resources, transmit two PUSCHs based on two SRS resource sets respectively at the same time-frequency resources, and/or transmit two PUSCHs according to two TCI states respectively at the same time-frequency resources. It should be noted that these two PUSCHs scheduled by the NW/gNB may be configured with the same number of transmission layers or different number of transmission layers.

In some implementations, if the UE is configured with SFN (e.g., the UE may be provided with an RRC parameter (e.g., sfnSchemePusch) set to a first scheme (e.g., ‘sfnSchemeA’) or a second scheme (e.g., ‘sfnSchemeB’)), the two PUSCHs scheduled to transmit with STxMP operation may carry the same TB. In addition, the number of transmission layers of two PUSCHs may be the same. For example, the UE may be indicated to apply the same transmission layers (e.g., one transmission layer or two transmission layers) to transmit two PUSCHs at the same time-frequency resources by the gNB. The two PUSCHs may be configured with the same DM-RS port(s) on the SFN mode.

In a case that the UE is indicated to perform CB based PUSCH transmission with STxMP operation for SFN mode, the UE may be indicated two transmission beams, two transmission precoders, and/or one or two power control parameter sets.

In some implementations, two transmission beams indicated to a UE by the NW/gNB to perform PUSCH transmission (e.g., CB based or non-CB based PUSCH transmission) with STxMP operation for the SFN mode may be provided in one or two DCI fields (e.g., a first SRS resource indicator and a second SRS resource indicator, a first TCI field and a second TCI field, a SRS resource indication, or a TCI field) included in a UL DCI (e.g., DCI format 0_1 and/or 0_2), one or two DCI fields (e.g., a first TCI field and a second TCI field, or a TCI field) included in a DL DCI (e.g., DCI format 1_1 and/or 1_2), and/or two RRC IEs/higher layer parameters (e.g., a first SRS resource indicator and a second SRS resource indicator, or a first TCI state and a second TCI state) included in an RRC IE (e.g., rrc-ConfiguredUplinkGrant). It should be noted that the UE may receive the DCI (e.g., DL DCI, UL DCI) including DCI fields from the NW/gNB. In response to the reception of the DCI, the UE may apply and/or configure the information/parameters indicated in the DCI fields. It should be noted that the UE may receive the RRC message including the RRC IEs and/or higher layer parameters from the NW/gNB. In response to the reception of the RRC message, the UE may apply and/or configure the RRC IEs and/or higher layers parameters indicated in the RRC message. In some implementations, the UE may receive, from a BS, a first TCI state indication, a second TCI state indication, a first SRS resource set, and a second SRS resource set, for configuring the STxMP operation. The UE may perform a first PUSCH transmission associated with the first SRS resource set and a second PUSCH transmission associated with the second SRS resource set simultaneously, where the first TCI state indication is applied to the first PUSCH transmission, and the second TCI state indication is applied to the second PUSCH transmission.

In some implementations, two beams indicated to a UE by the gNB/NW to perform STxMP operation for the SFN mode may be provided via two DCI fields included in a UL DCI (e.g., DCI format 0_1 and/or 0_2). The two DCI fields may be a first SRI field and a second SRI field, and candidate SRIs in the second SRI field may be a subset of candidate SRIs in the first SRI field. For example, if the number of rank (or layer) of the SRI indicated in the first SRI field is N, the candidate SRIs in the second SRI field may be the candidate SRIs with N ranks (or layers) in the first SRI fields. It should be noted that the first SRI field and the second SRI field may be used to indicate a first SRI and a second SRI applied for the PUSCH transmissions toward two TRPs respectively or applied for the two PUSCH transmissions associated with two SRS resource sets respectively. It should be noted that the first SRI may indicate one of the SRS resources in the first SRS resource set and the second SRI may indicate one of the SRS resources in the second SRS resource set. The first SRS resource set and the second SRS resource set may be associated with a first TRP and a second TRP respectively. The first TRP and the second TRP may be associated with a serving cell of a BS.

In some implementations, two beams indicated to a UE by the gNB/NW to perform STxMP operation may be provided via two DCI fields included in a UL DCI (e.g., DCI format 0_1 and/or 0_2) or a DL DCI (e.g., DCI format 1_1 and/or 1_2). The two DCI fields may include a first TCI field and a second TCI field, and these two TCI fields may be used to indicate a first TCI state and a second TCI state applied for the PUSCH transmissions toward two TRPs respectively or applied for the two PUSCH transmissions associated with two SRS resource sets respectively.

In some implementations, two beams indicated to a UE by the gNB/NW to perform STxMP operation may be provided via a DCI field included in a UL DCI (e.g., DCI format 0_1 and/or 0_2) or a DL DCI (e.g., DCI format 1_1 or 1_2). The DCI fields may include a TCI field, and at least one codepoint in the TCI field may be used to indicate two TCI states. The indicated two TCI states (e.g., a first TCI state and a second TCI state) in the TCI field may be applied for the PUSCH transmissions toward two TRPs respectively or applied for the two PUSCH transmissions associated with two SRS resource sets respectively. It should be noted that the codepoint in the TCI field may be associated with a codepoint in a MAC CE used for TCI state activation. Therefore, at least one codepoint in the MAC CE used for TCI state activation may include two TCI states.

In some implementations, two beams indicated to a UE by the gNB/NW to perform STxMP operation may be provided via two RRC IEs/higher layer parameters in an RRC IE (e.g., rrc-ConfiguredUplinkGrant). The two RRC IEs/higher layer parameters may indicate a first TCI state and a second TCI state applied for the PUSCH transmissions toward two TRPs respectively or applied for the two PUSCH transmissions associated with two SRS resource sets respectively. Alternatively, the two RRC IEs/higher layer parameters may indicate a first SRI and a second SRI applied for the PUSCH transmissions toward two TRPs respectively or applied for the two PUSCH transmissions associated with two SRS resource sets respectively. It should be noted that the first SRI may indicate one of the SRS resources in a first SRS resource set and the second SRI may indicate one of the SRS resources in a second SRS resource set. The first SRS resource set and the second SRS resource set may be associated with a first TRP and a second TRP respectively. The first TRP and the second TRP may be associated with a serving cell of a BS.

In some implementations, two transmission precoders indicated to a UE by the NW/gNB to perform PUSCH transmission (e.g., CB based PUSCH transmission) with STxMP operation for the SFN mode may be provided in the two DCI fields (e.g., a first TPMI field and a second TPMI field) included in a UL DCI (e.g., DCI format 0_1 and/or 0_2) and/or the two RRC IEs/higher layer parameters (e.g., a first TPMI and a second TPMI) included in an RRC IE (e.g., rrc-ConfiguredUplinkGrant).

In some implementations, two precoders indicated to a UE by the gNB/NW to perform STxMP operation may be provided via two DCI fields included in a UL DCI (e.g., DCI format 0_1 and/or 0_2). The two DCI fields may include a first TPMI field and a second TPMI field, and candidate TPMIs in the second TPMI field may be a subset of candidate TPMIs in the first TPMI field. For example, if the number of transmission layers of the TPMI indicated in the first TPMI field is M, the candidate TPMIs in the second TPMI field may be the candidate TPMIs with M transmission layers in the first TPMI fields. It should be noted that the first TPMI field and the second TPMI field may be used to indicate a first TPMI and a second TPMI applied for the PUSCH transmissions toward two TRPs respectively or applied for the two PUSCH transmissions associated with two SRS resource sets respectively. It should be noted that the candidate TMPIs associated with the first TPMI field and the second TPMI field may be included in the same TPMI table. It should be noted that the TPMI field may be used to provide the precoding information and number of layers. In addition, the TPMI field may be referred to as “Precoding information and number of layers” field.

In some implementations, two TPMIs indicated to a UE by the gNB/NW to perform STxMP operation may be provided via two RRC IEs/higher layer parameters in an RRC IE (e.g., rrc-ConfiguredUplinkGrant). The two RRC IEs/higher layer parameters may indicate a first TPMI (e.g., a first precodingAndNumberOfLayers) and a second TPMI (e.g., a second precodingAndNumberOfLayers) applied for the PUSCH transmissions toward two TRPs respectively or applied for the two PUSCH transmissions associated with two SRS resource sets respectively. It should be noted that a first SRS resource set and a second SRS resource set may be associated with a first TRP and a second TRP respectively. It should be noted that the TPMI field may be used to provide the precoding information and number of layers. In addition, the TPMI field may be referred to “Precoding information and number of layers” field.

In a case that the UE is indicated to perform non-CB based PUSCH transmission with STxMP operation for SFN mode, the UE may be indicated two transmission beams, two transmission precoders, and/or one or two power control parameter sets.

In some implementations, two transmission precoders indicated to a UE by the NW/gNB to perform PUSCH transmission (e.g., non-CB based PUSCH transmission) with STxMP operation for SFN mode may be provided in two DCI fields (e.g., a first SRI field and a second SRI field) included in a UL DCI (e.g., DCI format 0_1 and/or 0_2) and/or two RRC IEs/parameters (e.g., a first SRI and a second SRI) included in an RRC IE (e.g., rrc-ConfiguredUplinkGrant).

In some implementations, for the non-CB based PUSCH transmission (e.g., the higher layer parameter txConfig in pusch-Config is set to ‘non-codebook’) with STxMP operation, the UE may determine its two transmission precoders based on a first SRI and a second SRI indicated by two DCI fields (e.g., a first SRI field and a second SRI field) included in a UL DCI (e.g., DCI format 0_1 and/or 0_2). The two DCI fields may be the first SRI field and the second SRI field, and candidate SRIs in the second SRI field may be a subset of candidate SRIs in the first SRI field. For example, if the number of ranks (or layers) of the SRI indicated in the first SRI field is K, the candidate SRIs in the second SRI field may be the candidate SRIs with K ranks (or layers) in the first SRI fields. It should be noted that the first SRI field and the second SRI field may be used to indicate a first SRI and a second SRI applied for the PUSCH transmissions toward two TRPs respectively or applied for the two PUSCH transmissions associated with two SRS resource sets respectively.

In some implementations, two transmission precoders indicated to a UE by the gNB/NW to perform STxMP operation may be provided via two RRC IEs/higher layer parameters in an RRC IE (e.g., rrc-ConfiguredUplinkGrant). The two RRC IEs/higher layer parameters may indicate a first SRI and a second SRI applied for the PUSCH transmissions toward two TRPs respectively or applied for the two PUSCH transmissions associated with two SRS resource sets respectively.

It should be noted that the first SRI may indicate one of the SRS resources in a first SRS resource set and the second SRI may indicate one of the SRS resources in a second SRS resource set. The first SRS resource set and the second SRS resource set may be associated with a first TRP and a second TRP respectively.

In some implementations, if the UE is configured with SDM by RRC signaling/message, MAC CE or DCI, the same or different number of transmission layers may be configured to two PUSCHs. In a case that the same number of transmission layers is configured to two PUSCHs, the number of transmission layer(s) may be 1, 2 or 4. In a case that each PUSCH is configured with a different number of transmission layers, the possible combinations of the number of transmission layers corresponding to two PUSCHs are listed in Table 1. Table 1 illustrates possible combinations of the number of transmission layers for STxMP according to an example implementation of the present disclosure. It should be noted that the first number of transmission layers and the second number of transmission layers in Table 1 correspond to the first PUSCH and the second PUSCH respectively. The first PUSCH and the second PUSCH are scheduled to transmit toward different TRPs according to the different SRS resource sets (e.g., the first SRS resource set corresponding to the first TRP and the second SRS resource set corresponding to the second TRP) and/or different TCI states (e.g., the first TCI state corresponding to the first TRP and the second TCI state corresponding to the second TRP). The first SRS resource set may be the SRS resource set with the lowest index between two SRS resource sets with usage set to ‘codebook’ or ‘non-codebook’.

TABLE 1

| The first number of | The second number of |
|---|---|
| transmission layers | transmission layers |
| 1 | 2 |
| 2 | 1 |
| 1 | 3 |
| 3 | 1 |
| 4 | 0 |
| 0 | 4 |
| 2 | 0 |
| 0 | 2 |
| 1 | 0 |
| 0 | 1 |

In a case that the UE is indicated to perform CB based PUSCH transmission with STxMP operation for SDM mode, the UE may be indicated two transmission beams, two transmission precoders, and/or one or two power control parameter sets.

In some implementations, two transmission beams indicated to a UE by the NW/gNB to perform PUSCH transmission (e.g., CB based or non-CB based PUSCH transmission) with STxMP operation for the SDM mode may be provided in the one or two DCI fields (e.g., a first SRS resource indicator and a second SRS resource indicator, a first TCI field and a second TCI field, a SRS resource indication, or a TCI field) included in a UL DCI (e.g., DCI format 0_1 and/or 0_2), one or two DCI fields (e.g., a first TCI field and a second TCI field or a TCI field) included in a DL DCI (e.g., DCI format 1_1 and/or 1_2) and/or two RRC IEs/higher layer parameters (e.g., a first SRS resource indicator and a second SRS resource indicator, or a first TCI state and a second TCI state) included in an RRC IE (e.g., rrc-ConfiguredUplinkGrant). It should be noted that the UE may receive the DCI (e.g., DL DCI, UL DCI) including DCI fields from the NW/gNB. In response to the reception of the DCI, the UE may apply and/or configure the information/parameters indicated in the DCI fields. It should be noted that the UE may receive the RRC message including the RRC IEs and/or higher layer parameters from the NW/gNB. In response to the reception of the RRC message, the UE may apply and/or configure the RRC IEs and/or higher layers parameters indicated in the RRC message. In some implementations, the UE may receive, from a BS, a first TCI state indication, a second TCI state indication, a first SRS resource set, and a second SRS resource set, for configuring the STxMP operation. The UE may perform a first PUSCH transmission associated with the first SRS resource set and a second PUSCH transmission associated with the second SRS resource set simultaneously, where the first TCI state indication is applied to the first PUSCH transmission, and the second TCI state indication is applied to the second PUSCH transmission.

In some implementations, two beams indicated to a UE by the gNB/NW to perform STxMP operation for the SDM mode may be provided via two DCI fields included in a UL DCI (e.g., DCI format 0_1 and/or 0_2). The two DCI fields may be a first SRI field and a second SRI field, and candidate SRIs in the second SRI field may be a subset of candidate SRIs in the first SRI field. For example, if the number of ranks (or layers) of the SRI indicated in the first SRI field is N, the candidate SRIs in the second SRI field may be the candidate SRIs with P-N ranks (or layers) in the first SRI field, where P may be the maximum number/total number of rank(s) (or layer(s)) configured by the NW/gNB for the STxMP PUSCH transmission. It should be noted that P may be configured via RRC signaling (or higher layer parameter). For example, if the number of ranks (or layers) of the SRI indicated in the first SRI field is N, the candidate SRIs in the second SRI field may be the candidate SRIs with x ranks (or layers) in the first SRI field, where x may be a value ranging from P-N to 1 or from P-N to 0, and P may be the maximum number/total number of rank(s) (or layer(s)) configured by the NW/gNB for the STxMP PUSCH transmission. It should be noted that P may be configured via RRC signaling (or higher layer parameter).

In some implementations, two beams indicated to a UE by the gNB/NW to perform STxMP operation for the SDM mode may be provided via two DCI fields included in a UL DCI (e.g., DCI format 0_1 and/or 0_2). The two DCI fields may include a first SRI field and a second SRI field, and candidate SRIs in the first SRI field and the second SRI field may be independently selected in the same SRI table.

In some implementations, two beams indicated to a UE by the gNB/NW to perform STxMP operation may be provided via two DCI fields included in a UL DCI (e.g., DCI format 0_1 and/or 0_2) or a DL DCI (e.g., DCI format 1_1 and/or 1_2). The two DCI fields may include a first TCI field and a second TCI field, and these two TCI fields may be used to indicate a first TCI state and a second TCI state applied for the PUSCH transmissions toward two TRPs respectively or applied for the two PUSCH transmissions associated with two SRS resource sets respectively.

In some implementations, two beams indicated to a UE by the gNB/NW to perform STxMP operation may be provided via a DCI field included in a UL DCI (e.g., DCI format 0_1 and/or 0_2) or a DL DCI (e.g., DCI format 1_1 or 1_2). The DCI fields may include a TCI field, and at least one codepoint in the TCI field may be used to indicate two TCI states. The indicated two TCI states (e.g., a first TCI state and a second TCI state) in the TCI field may be applied for the PUSCH transmissions toward two TRPs respectively or applied for the two PUSCH transmissions associated with two SRS resource sets respectively. It should be noted that the codepoint in the TCI field may be associated with a codepoint in a MAC CE used for TCI state activation. Therefore, the at least one codepoint in the MAC CE used for TCI state activation may include two TCI states.

In some implementations, two beams indicated to a UE by the gNB/NW to perform STxMP operation may be provided via two RRC IEs/higher layer parameters in an RRC IE (e.g., rrc-ConfiguredUplinkGrant). The two RRC IEs/higher layer parameters may indicate a first TCI state and a second TCI state applied for the PUSCH transmissions toward two TRPs respectively or applied for the two PUSCH transmissions associated with two SRS resource sets respectively. Alternatively, the two RRC IEs/higher layer parameters may indicate a first SRI and a second SRI applied for the PUSCH transmissions toward two TRPs respectively or applied for the two PUSCH transmissions associated with two SRS resource sets respectively.

It should be noted that the first SRI field and the second SRI field may be used to indicate the first SRI and the second SRI applied for the PUSCH transmissions toward two TRPs respectively or applied for the two PUSCH transmissions associated with two SRS resource sets respectively. It should be noted that the first SRI may indicate one of the SRS resources in the first SRS resource set and the second SRI may indicate one of the SRS resources in the second SRS resource set. The first SRS resource set and the second SRS resource set may be associated with a first TRP and a second TRP respectively. The first TRP and the second TRP may be associated with a serving cell of a BS.

In some implementations, two transmission precoders indicated to a UE by the NW/gNB to perform PUSCH transmission (e.g., CB based PUSCH transmission) with STxMP operation for the SDM mode may be provided in the two DCI fields (e.g., a first TPMI field and a second TPMI field) included in a UL DCI (e.g., DCI format 0_1 and/or 0_2) and/or the two RRC IEs/higher layer parameters (e.g., a first TPMI and a second TPMI) included in an RRC IE (e.g., rrc-ConfiguredUplinkGrant).

In some implementations, two precoders indicated to a UE by the gNB/NW to perform STxMP operation may be provided via two DCI fields included in a UL DCI (e.g., DCI format 0_1 and/or 0_2). The two DCI fields may include a first TPMI field and a second TPMI field, and candidate TPMIs in the second TPMI field may be a subset of candidate TPMIs in the first TPMI field. For example, if the number of transmission layers of the TPMI indicated in the first TPMI field is M, the candidate TPMIs in the second TPMI field may be the candidate TPMIs with Q-M transmission layers in the first TPMI fields, where Q may be the maximum number/total number of transmission layers (or ranks) configured by the NW/gNB for the STxMP PUSCH transmission. For example, if the number of transmission layers of the TPMI indicated in the first TPMI field is M, the candidate TPMIs in the second TPMI field may be the candidate TPMIs with x transmission layers in the first TPMI fields, where x may be a value ranging from Q-M to 1 or from Q-M to 0, and Q may be the maximum number/total number of transmission layers (or ranks) configured by the NW/gNB for the STxMP PUSCH transmission and. It should be noted that the Q may be configured via RRC signaling (or higher layer parameter). It should be noted that the TPMI field may be used to provide the precoding information and number of layers. In addition, the TPMI field may be referred to as “Precoding information and number of layers” field.

In some implementations, two transmission precoders indicated to a UE by the gNB/NW to perform STxMP operation for the SDM mode may be provided via two DCI fields included in a UL DCI (e.g., DCI format 0_1 and/or 0_2). The two DCI fields may include a first TPMI field and a second TPMI field, and candidate TPMIs in the first TPMI field and the second TPMI field may be independently selected in the same TPMI table. It should be noted that the TPMI field may be used to provide the precoding information and number of layers. In addition, the TPMI field may be referred to as “Precoding information and number of layers” field.

It should be noted that the first TPMI field and the second TPMI field may be used to indicate a first TPMI and a second TPMI applied for the PUSCH transmissions toward two TRPs respectively or applied for the two PUSCH transmissions associated with two SRS resource sets respectively. It should be noted that the candidate TMPIs associated with the first TPMI field and the second TPMI field may be included in the same TPMI table. It should be noted that the TPMI field may be used to provide the precoding information and number of layers. In addition, the TPMI field may be referred to as “Precoding information and number of layers” field.

In some implementations, two TPMIs indicated to a UE by the gNB/NW to perform STxMP operation may be provided via two RRC IEs/higher layer parameters in an RRC IE (e.g., rrc-ConfiguredUplinkGrant). The two RRC IEs/higher layer parameters may indicate a first TPMI (e.g., a first precodingAndNumberOfLayers) and a second TPMI (e.g., a second precodingAndNumberOfLayers) applied for the PUSCH transmissions toward two TRPs respectively or applied for the two PUSCH transmissions associated with two SRS resource sets respectively. It should be noted that a first SRS resource set and a second SRS resource set may be associated with a first TRP and a second TRP respectively. It should be noted that the TPMI field may be used to provide the precoding information and number of layers. In addition, the TPMI field may be referred to as “Precoding information and number of layers” field.

In a case that the UE is indicated to perform non-CB based PUSCH transmission with STxMP operation for the SDM mode, the UE may be indicated two transmission beams, two transmission precoders, and/or one or two power control parameter sets.

In some implementations, two transmission precoders indicated to a UE by the NW/gNB to perform PUSCH transmission (e.g., non-CB based PUSCH transmission) with STxMP operation for the SDM mode may be provided in the two DCI fields (e.g., a first SRI field and a second SRI field) included in a UL DCI (e.g., DCI format 0_1 and/or 0_2) and/or the two RRC IEs/parameters (e.g., a first SRI and a second SRI) included in an RRC IE (e.g., rrc-ConfiguredUplinkGrant).

In some implementations, for the non-CB based PUSCH transmission (e.g., the higher layer parameter txConfig in pusch-Config is set to ‘non-codebook’) with STxMP operation, the UE may determine its two transmission precoders based on a first SRI and a second SRI indicated by two DCI fields (e.g., a first SRI field and a second SRI field) included in a UL DCI (e.g., DCI format 0_1 and/or 0_2). The two DCI fields may include the first SRI field and the second SRI field, and candidate SRIs in the second SRI field may be a subset of candidate SRIs in the first SRI field. For example, if the number of ranks (or layers) of the SRI indicated in the first SRI field is K, the candidate SRIs in the second SRI field may be the candidate SRIs with P-K ranks (or layers) in the first SRI fields, where P may be the maximum number/total number of rank(s) (or layer(s)) configured by the NW/gNB for the STxMP PUSCH transmission. It should be noted that the P may be configured via RRC signaling (or higher layer parameter).

In some implementations, two transmission precoders indicated to a UE by the gNB/NW to perform STxMP operation for the SDM mode may be provided via two DCI fields included in a UL DCI (e.g., DCI format 0_1 and/or 0_2). The two DCI fields may be a first SRI field and a second SRI field, and the indicated SRIs (e.g., a first indicated SRI and a second indicated SRI) in the first SRI field and the second SRI field may be independently selected in the same or different SRI table(s) by the gNB/NW.

In some implementations, a UE may be configured with two RRC parameters/higher layer parameters (e.g., Lₘₐₓ1 and Lₘₐₓ2) by the gNB/NW. Each RRC parameter/higher layer parameter may be used to indicate the maximum number of layers for a first PUSCH and a second PUSCH supported by the UE. In a case that Lₘₐₓ1 is equal to Lₘₐₓ2, a first SRI indicated in a first SRI field and a second SRI indicated in a second SRI field may be defined in the same SRI table or different SRI tables. For example, if Lₘₐₓ1=Lₘₐₓ2=1, the first indicated SRI and the second indicated SRI indicated by the gNB/NW may be one of the candidate SRIs in the same SRI table. An example SRI table is shown in Table 2. Table 2 illustrates a first SRI indication or second SRI indication for non-CB based PUSCH transmission when Lₘₐₓ1=Lₘₐₓ2=1 according to an example implementation of the present disclosure.

TABLE 2

| Bit field | SRI(s), | Bit field | SRI(s), | Bit field | SRI(s), |
|---|---|---|---|---|---|
| mapped to | N_{SRS} = | mapped to | N_{SRS} = | mapped to | N_{SRS} = |
| index | 2 | index | 3 | index | 4 |
| 0 | 0 | 0 | 0 | 0 | 0 |
| 1 | 1 | 1 | 1 | 1 | 1 |
| | | 2 | 2 | 2 | 2 |
| | | 3 | reserved | 3 | 3 |

For example, if Lₘₐₓ1=Lₘₐₓ2=2, the first indicated SRI and the second indicated SRI indicated by the gNB/NW may be one of the candidate SRIs in different SRI tables respectively. The candidate SRIs corresponding to the second indicated SRI may be related to the number of ranks (layers) indicated by the first indicated SRI. For example, if the number of ranks indicated by the first indicated SRI in the first SRI table is 2, the candidate SRIs corresponding to the second indicated SRI may be the candidate SRIs with the number of ranks as 2 in the second SRI table.

In some implementations, two transmission precoders indicated to a UE by the gNB/NW to perform STxMP operation may be provided via two RRC IEs/higher layer parameters in an RRC IE (e.g., rrc-ConfiguredUplinkGrant). The two RRC IEs/higher layer parameters may indicate a first SRI and a second SRI applied for the PUSCH transmissions toward two TRPs respectively or applied for the two PUSCH transmissions associated with two SRS resource sets respectively.

It should be noted that the first SRI field and the second SRI field may be used to indicate the first SRI and the second SRI applied for the PUSCH transmissions toward two TRPs respectively or applied for the two PUSCH transmissions associated with two SRS resource sets respectively. It should be noted that the first SRI may indicate one of the SRS resources in the first SRS resource set and the second SRI may indicate one of the SRS resources in the second SRS resource set. The first SRS resource set and the second SRS resource set may be associated with a first TRP and a second TRP respectively.

As mentioned previously, TRP specific power control may be needed since STxMP based UL transmission may allow a UE to transmit UL channels (e.g., PUSCH or PUCCH) toward multiple TRPs/gNBs located at different geographic areas. For the power control mechanisms, gNB/NW may determine the power control parameters (e.g., TPC command, pathloss RS and/or P₀) for the corresponding UL transmission based on the PHR transmitted by the UE. Therefore, how to enhance PHR for STxMP may be a critical issue.

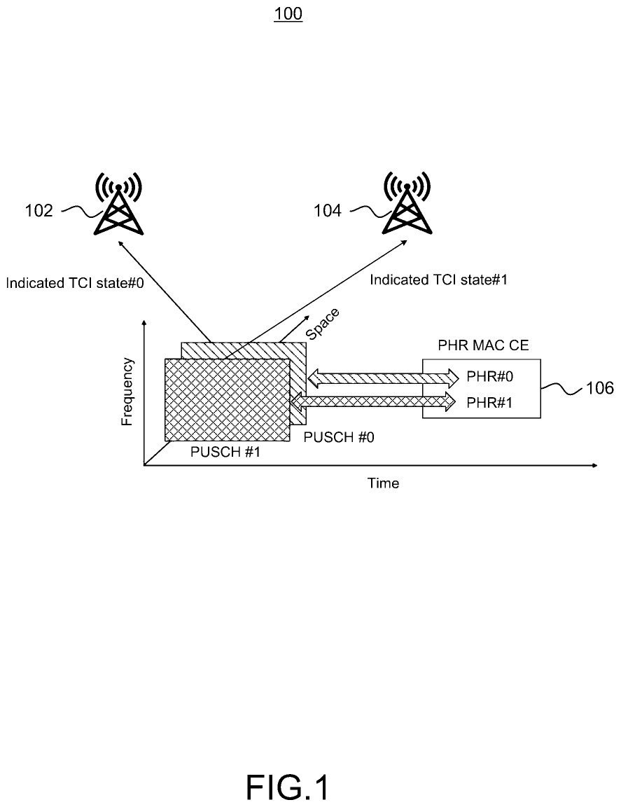

FIG. 1 illustrates 100 a TRP-specific power control for STxMP operation according to an example implementation of the present disclosure. A UE may perform a first PUSCH transmission PUSCH #0 associated with TRP #0 102 and a second PUSCH transmission PUSCH #1 associated with TRP #1 104 simultaneously, where TRP #0 102 and TPR #1 104 may be associated with a serving cell of a BS. The UE may receive transmission parameters #0 and transmission parameter #1 from the BS. The UE may receive a first SRS resource set and a second SRS resource set from the BS, where the first SRS resource set and the second SRS resource set are associated with TRP #0 102 and TRP #1 104, respectively. In some implementations, the UE may receive a first indicated TCI state #0 and a second indicated TCI state #1 from the BS. The UE may apply the first indicated TCI state #0 to PUSCH #0 toward TRP #0 102 and apply the second indicated TCI state #1 to PUSCH #1 toward TRP #1 104.

As illustrated in FIG. 1, for STxMP based PUSCH transmission, PUSCH #0 and PUSCH #1 may be transmitted toward TRP #0 102 and TRP #1 104, respectively, at the same time-frequency resources according to two sets of transmission parameters (e.g., beam, TCI state, SRI, TPMI and/or TPC) indicated by the BS (e.g., a gNB, NW). In some implementations, PUSCH #0 and PUSCH #1 may be partially or fully overlapped in time-frequency resources. PUSCH #0 and PUSCH #1 transmission may be associated with SRS resource set #0 and SRS resource set #1 respectively, and SRS resource set #0 and SRS resource set #1 may be associated with TRP #0 and TRP #1 respectively. In addition, a PHR MAC CE 106 (e.g., single entry PHR MAC CE and/or multi-entry PHR MAC CE) may include PHR #0 and PHR #1, which may be calculated based on the PUSCH #0 and PUSCH #1, respectively. In some implementations, PHR #0 may be a Type-1 PH and may be calculated based on a first pathloss RS associated with the first indicated TCI state #0. PHR #1 may be a Type-1 PH and may be calculated based on a second pathloss RS associated with the second indicated TCI state #1.

The PHR(s) associated with different PUSCH transmissions toward different TRPs may be carried in a PHR MAC CE 106. The PHR(s) may be calculated based on actual (or real) transmission or reference format. For STxMP based PUSCH transmission, the PHRs corresponding to two TRPs/SRS resource sets may be calculated based on actual (or real) transmission or reference format at the same time.

In some implementations, if one or more STxMP based PUSCH transmissions occur between the time at which the PHR is triggered and the time at which the PHR MAC CE is transmitted, the two PHRs corresponding to two TRPs/SRS resource sets may be calculated based on one or more actual (or real) PUSCH transmissions associated with STxMP based PUSCH transmissions.

In some implementations, if both PUSCH transmissions associated with STxMP based PUSCH transmissions do not occur between the time at which the PHR is triggered and the time at which the STxMP based PHR MAC CE is transmitted, two PHRs corresponding to two TRPs/SRS resource sets may be calculated based on the reference format.

In some implementations, if one PUSCH is transmitted by the UE toward one of the two TRPs configured for STxMP operation or one PUSCH is transmitted based on one of the two SRS resource sets configured for STxMP operation between the time at which the PHR is triggered and the time at which the STxMP based PHR MAC CE is transmitted, the PHR corresponding to the transmitted PUSCH may be calculated based on the actual (or real) PUSCH transmission and the other PHR may be calculated based on the reference format.

In some implementations, if a UE is provided with one higher layer parameter (e.g., twoPHRMode) on an active UL BWP b of carrier f of serving cell c and is provided with two SRS resource sets in srs-ResourceSetToAddModList or srs-ResourceSetToAddModListDCI-0-2 with usage set to ‘codebook’ or ‘non-codebook’, the UE may provide/calculate Type-1 PHRs in a slot n. It should be noted that the higher layer parameter twoPHRMode may be used to indicate whether the power headroom reported as two PHRs (each PHR associated with an SRS resource set) is enabled or not.

In some implementations, if the UE transmits PUSCHs associated with the two SRS resource sets respectively in slot n, the UE may provide/calculate a first Type-1 PHR and a second Type-1 PHR for two actual PUSCH transmissions associated with a first SRS resource set and a second SRS resource set that overlaps with slot n. It should be noted that the first Type-1 PHR and the second Type-1 PHR may be included in a PHR MAC CE (e.g., single entry PHR MAC CE or multi-entry PHR MAC CE) scheduled by the gNB/NW.

In some implementations, if the UE provides a first Type-1 PHR for a first reference PUSCH transmission associated with a first SRS resource set, the UE may provide a second Type-1 PHR for a reference PUSCH transmission associated with a second SRS resource set.

It should be noted that a Type-1 PHR may be used to provide the difference between the nominal UE maximum transmit power and the estimated power for PUSCH transmission per activated Serving Cell.

In some implementations, a UE may report its capability on whether to support STxMP based PUSCH or PUCCH transmission, to the NW/gNB. In some implementations, the UE may firstly receive a UE capability enquiry message from the NW/gNB. In response to the reception of the UE capability enquiry message, the UE may transmit a UE capability information message including the information of whether to support STxMP based on PUSCH or PUCCH transmission to the NW/gNB.

In some implementations, a UE may be indicated to perform STxMP operation (e.g., STxMP based PUSCH transmission, STxMP based PUCCH transmission, and/or STxMP based SRS transmission), by NW/gNB via an RRC parameter/higher layer parameter in an RRC message or in a NAS signaling. In a case that the UE receives an RRC parameter/higher layer parameter indicating to enable the STxMP operation, the UE may perform STxMP based UL transmission (e.g., PUSCH transmission, PUCCH transmission, or SRS transmission).

In some implementations, a UE may be indicated to perform STxMP based PUSCH transmission with SFN mode or SDM mode. The UE may receive, from a BS (e.g., a gNB), an RRC parameter/higher layer parameter that indicates which mode is configured to the UE for the STxMP PUSCH transmission. In some implementations, the UE may receive a first RRC parameter from the BS, the first RRC parameter indicating to the UE to perform STxMP based PUSCH transmission, the first RRC parameter further indicating one of an SFN scheme or an SDM scheme for the STxMP based PUSCH transmission.

In some implementations, a UE may be configured with an RRC parameter/higher layer parameter that indicates whether to perform STxMP based transmission for the corresponding PUSCH transmission. In addition, the RRC parameter/higher layer parameter may also indicate which scheme (e.g., SFN, SFN scheme A, SFN scheme B, and/or SDM) is applied for the corresponding STxMP based PUSCH operation.

In some implementations, a UE may be configured with an RRC parameter/higher layer parameter that indicates whether to perform STxMP based transmission for the corresponding PUCCH transmission. In addition, the RRC parameter/higher layer parameter may also indicate whether the SFN scheme is applied for the corresponding STxMP base PUCCH operation or not.

In some implementations, a UE may be configured with a first RRC parameter/higher layer parameter, the first RRC parameter/higher layer parameter indicating whether to perform STxMP based transmission for a PUSCH transmission. In addition, the UE may be configured with a second RRC parameter/higher layer parameter, the second RRC parameter/higher layer parameter indicating whether to perform SDM scheme for the PUSCH transmission. If the UE is configured with the first RRC parameter/higher layer parameter and the second RRC parameter/higher layer parameter for the PUSCH transmission, the UE may apply the SDM scheme for the STxMP based PUSCH transmission.

In some implementations, a UE may be configured with a first RRC parameter/higher layer parameter, the first RRC parameter/higher layer parameter indicating whether to perform STxMP based transmission for a PUSCH transmission. In addition, the UE may be configured with a second RRC parameter/higher layer parameter, the second RRC parameter/higher layer parameter indicating whether to perform SFN scheme for the PUSCH transmission. If the UE is configured with the first RRC parameter/higher layer parameter and the second RRC parameter/higher layer parameter for the PUSCH transmission, the UE may apply the SFN scheme for the STxMP based PUSCH transmission.

In some implementations, a UE may be configured with a first RRC parameter/higher layer parameter, the first RRC parameter/higher layer parameter indicating whether to perform STxMP based transmission for a PUCCH transmission. In addition, the UE may be configured with a second RRC parameter/higher layer parameter, the second RRC parameter/higher layer parameter indicating whether to perform SFN scheme for the PUCCH transmission. If the UE is configured with the first RRC parameter/higher layer parameter and the second RRC parameter/higher layer parameter for the PUCCH transmission, the UE may apply the SFN scheme for the STxMP based PUCCH transmission.

In some implementations, a UE may report its capability on whether to support SFN scheme for PUSCH or PUCCH transmission, to the NW/gNB. In some implementations, the UE may firstly receive a UE capability enquiry message from the NW/gNB. In response to the reception of the UE capability enquiry message, the UE may transmit a UE capability information message including the information of whether to support SFN scheme for PUSCH or PUCCH transmission to the NW/gNB.

In some implementations, a UE may report whether it supports SFN for PUSCH or PUCCH transmission, to the NW/gNB. Such information/RRC parameter, indicating whether the UE supports SFN for PUSCH or PUCCH transmission, may be included in the feature sets IE (e.g., featureSetsUplink).

In some implementations, a UE may report an RRC parameter (e.g., sfn-SchemeA-r18) to inform a gNB of whether the UE supports SFN scheme A for UL transmissions (e.g., PUSCH transmission and/or PUCCH transmission), to the NW/gNB.

In some implementations, a UE may report an RRC parameter (e.g., sfn-SchemeA-DynamicSwitching-r18) to inform a gNB of whether the UE supports dynamic switching between SFN scheme A and other schemes (e.g., single TRP transmission and/or multi-TRP based UL transmission with TDM), to the NW/gNB.

In some implementations, a UE may report an RRC parameter (e.g., sfn-SchemeA-PUSCH-only-r18) to inform a gNB of whether the UE only supports SFN scheme A for PUSCH transmission.

In some implementations, a UE may report an RRC parameter (e.g., sfn-SchemeA-PUCCH-only-r18) to inform a gNB of whether the UE only supports SFN scheme A for PUCCH transmission.

In some implementations, a UE may report an RRC parameter (e.g., sfn-SchemeB-r18) to inform a gNB of whether the UE supports SFN scheme B for UL transmissions (e.g., PUSCH transmission and/or PUCCH transmission).

In some implementations, a UE may report an RRC parameter (e.g., sfn-SchemeB-DynamicSwitching-r18) to inform a gNB of whether the UE supports dynamic switching between SFN scheme B and other schemes (e.g., single TRP transmission and/or multi-TRP based UL transmission with TDM).

In some implementations, a UE may report an RRC parameter (e.g., sfn-SchemeB-PUSCH-only-r18) to inform a gNB of whether the UE only supports SFN scheme B for PUSCH transmission.

In some implementations, a UE may report an RRC parameter (e.g., sfn-SchemeB-PUCCH-only-r18) to inform a gNB of whether the UE only supports SFN scheme B for PUCCH transmission.

In some implementations, a UE may be configured with SFN scheme (e.g., SFN scheme A and/or SFN scheme B) for the UL transmissions (e.g., PUSCH transmission and/or PUCCH transmission) by RRC signaling.

In some implementations, a UE may be configured with an RRC parameter/higher layer parameter to apply the SFN scheme for a PUSCH transmission. The RRC parameter/higher layer parameter may indicate which SFN scheme is applied to the PUSCH transmission.

In some implementations, a UE may be configured with an RRC parameter/higher layer parameter to apply the SFN scheme for a PUCCH transmission/STxMP based PUCCH transmission. The RRC parameter/higher layer parameter may indicate which SFN scheme is applied to the PUCCH transmission/STxMP based PUCCH transmission.

In some implementations, if a UE is configured with a first RRC parameter/higher layer parameter used to apply the SFN scheme for a PUSCH transmission and a second RRC parameter/higher layer parameter used to apply the SFN scheme for a PUCCH transmission, the UE may expect that the SFN scheme applied for the PUSCH transmission and the SFN scheme applied for the PUCCH transmission may be the same SFN scheme (e.g., SFN scheme A or SFN scheme B).

In some implementations, if a UE is configured with an RRC parameter/higher layer parameter indicating to the UE to perform SFN scheme for the corresponding UL transmission (e.g., PUSCH transmission or PUCCH transmission), the UE may perform STxMP based operation for the corresponding UL transmission (e.g., PUSCH transmission or PUCCH transmission).

It should be noted that a PUSCH transmission may be a single-TRP based PUSCH transmission, a STxMP based PUSCH transmission, and/or a multi-TRP based PUSCH transmission with TDM. It should be noted that a PUCCH transmission may be a single-TRP based PUCCH transmission, a STxMP based PUCCH transmission, and/or a multi-TRP based PUCCH transmission with TDM.

In some implementations, at least one of the following RRC parameters/higher layer parameters may be configured to a UE for a PHR corresponding to a PUSCH transmission.
phr-PeriodicTimer: It may be a value in the number of subframes for PHR reporting period for the corresponding PUSCH transmission (e.g., single TRP based PUSCH transmission, multi-TRP based PUSCH transmission with TDM, and/or STxMP based PUSCH transmission).
phr-ProhibitTimer: It may be a prohibit timer for the PHR for the corresponding PUSCH transmission (e.g., single TRP based PUSCH transmission, multi-TRP based PUSCH transmission with TDM and/or STxMP based PUSCH transmission). It may be a value in the number of subframes.
phr-Tx-PowerFactorChange: It may be a threshold (e.g., value in dB) configured to a UE for deciding whether to trigger the PHR.

In some implementations, for single TRP based PUSCH transmission or multi-TRP based PUSCH transmission with TDM, a UE may be configured with a RRC parameter/higher layer parameter (e.g., phr-Tx-PowerFactorChange) as a threshold. The UE may determine whether to trigger PHR according to the threshold. In some implementations, if the path loss has changed more than phr-Tx-PowerFactorChange dB for at least one RS used as pathloss reference for one activated serving cell of any MAC entity of which the active DL BWP, the UE may trigger PHR.

In some implementations, phr-Tx-PowerFactorChange may be an TRP specific parameter. For example, for STxMP based PUSCH transmission, a UE may be configured with phr-Tx-PowerFactorChange1 used for a first PUSCH associated with a first SRS resource set/a first TCI state/a first TRP and phr-Tx-PowerFactorChange2 used for a second PUSCH associated with a second SRS resource set/a second TCI state/a second TRP.

In some implementations, for STxMP based PUSCH transmission, a set of RRC parameters/higher layer parameters (e.g., phr-Tx-PowerFactorChange1 and phr-Tx-PowerFactorChange2) may be used to be the threshold values for the channel variation (e.g., path loss) for the different PUSCH transmission toward different TRPs. A first RRC parameter (e.g., phr-Tx-PowerFactorChange1) may be used as a first threshold value, which may be used to decide whether the path loss of the PUSCH transmission toward a first TRP triggers PHR or not. A second RRC parameter (e.g., phr-Tx-PowerFactorChange2) may be used as a second threshold value, which may be used to decide whether the path loss of the PUSCH transmission toward a second TRP triggers PHR or not.

In some implementations, for STxMP based PUSCH transmission, a UE may be configured with a first pathloss RS corresponding to a first PUSCH transmission associated with a first SRS resource set/a first TCI state/a first TRP/a first beam/a first panel, a second pathloss RS corresponding to a second PUSCH transmission associated with a second SRS resource set/a second TCI state/a second TRP/a second beam/a second panel, a first RRC parameter/higher layer parameter (e.g., phr-Tx-PowerFactorChange1) used as a first threshold value and a second RRC parameter/higher layer parameter (e.g., phr-Tx-PowerFactorChange2) used as a second threshold value by a gNB/NW. Referring to FIG. 1, PHR #0 may be calculated at least based on first pathloss RS associated with the first indicated TCI state #0 and PHR #1 may be calculated at least based on second pathloss RS associated with the second indicated TCI state #1.

In some implementations, if the path loss measured by the first pathloss RS is more than the first RRC parameter/higher layer parameter (e.g., phr-Tx-PowerFactorChange1 dB) or the path loss measured by the second pathloss RS is more than the second RRC parameter/higher layer parameter (e.g., phr-Tx-PowerFactorChange2 dB), the PHR corresponding to STxMP based PUSCH transmission may be triggered by the UE. In some implementations, if the path loss measured by the first pathloss RS is more than the first RRC parameter/higher layer parameter (e.g., phr-Tx-PowerFactorChange1) and the path loss measured by the second pathloss RS is more than the second RRC parameter/higher layer parameter (e.g., phr-Tx-PowerFactorChange2 dB), the PHR corresponding to STxMP based PUSCH transmission may be triggered by the UE.

In some implementations, phr-Tx-PowerFactorChange may be used for a first PUSCH associated with a first SRS resource set/a first TCI state/a first TRP and a second PUSCH associated with a second SRS resource set/a second TCI state/a second TRP. In some implementations, for STxMP based PUSCH transmission, a power change threshold may be associated with both the first PUSCH transmission and the second PUSCH transmission.

In some implementations, an RRC parameter/higher layer parameter (e.g., phr-Tx-PowerFactorChange) may be used as the threshold value for the channel variation (e.g., path loss) for the different PUSCH transmissions toward different TRPs. The RRC parameter (e.g., phr-Tx-PowerFactorChange) may be used as the threshold value to decide whether the path loss of each PUSCH transmission toward different TRPs is large enough or has changed enough to trigger PHR or not.

In some implementations, if the path loss of one of all PUSCH transmissions (occasion(s)) toward different TRPs is larger than and/or has changed more than a power change threshold (e.g., phr-Tx-PowerFactorChange dB), the PHR may be triggered by the UE. In some implementations, for STxMP based PUSCH transmission, the PHR for the STxMP based PUSCH transmission may be triggered in a case that either a first path loss associated with the first PUSCH transmission or a second path loss associated with the PUSCH transmission has changed more than the power change threshold.

In some implementations, if all path losses of all PUSCH transmissions toward different TRPs are larger than and/or have changed more than the phr-Tx-PowerFactorChange dB, the PHR may be triggered by the UE.

In some implementations, at least one of the following RRC parameters/higher layer parameters may be configured to a UE for a PHR corresponding to a PUSCH transmission.
multiplePHR: It may be an RRC parameter/higher layer parameter indicating to a UE to report PHR using single entry PHR MAC CE or multiple entry PHR MAC CE for the corresponding PUSCH transmission (e.g., single TRP based PUSCH transmission, multi-TRP based PUSCH transmission with TDM, and/or STxMP based PUSCH transmission). The value of this parameter set to True may mean the multiple entry PHR MAC CE, while the value of this parameter set to False may mean the single entry PHR MAC CE.
twoPHRMode: It may be used to indicate whether the power headroom can be reported as two PHRs (each PHR associated with an SRS resource set or a TCI state) or not. In some implementations, if a UE is configured with twoPHRMode, the UE may transmit two PHRs (each PHR associated with an SRS resource set/a TCI state/a TRP/a beam/a panel) corresponding to a serving cell in a PHR MAC CE.

In some implementations, if a UE is configured with twoPHRMode and configured with the STxMP PUSCH transmission feature, the two PHs together with one P_{CMAX,f,c} for the serving cell may be reported. It should be noted that P_{CMAX,f,c} may be the UE configured maximum output power for carrier f of serving cell c.

In some implementations, a PHR MAC CE used to carry PHRs corresponding to STxMP based PUSCH transmission may include three octets, including following fields:
R: Reserved bits, set to 0;
Power Headroom (PH i): This field indicates the power headroom level, where a first PH may be associated with a first SRS resource set (e.g., SRS-ResourceSet with a lower srs-ResourceSetId), a first TCI state (e.g., the TCI state with a lower TCI state ID), a first beam, a first TRP, or a first panel, and a second PH may be associated with a second SRS resource set (e.g., the SRS-ResourceSet with a higher srs-ResourceSetId), a second TCI state (e.g., the TCI state with a higher TCI state ID), a second beam, a second TRP, or a second panel. PH fields for a Serving Cell may be included in ascending order based on the index i. The length of each PH i field may be 6 bits.
P: If mpe-Reporting-FR2 is configured and the Serving Cell operates on FR2, the MAC entity may set this field to 0 if the applied P-MPR value is less than P-MPR_00 as specified in TS 38.133 V17.8.0 and to 1 otherwise. If mpe-Reporting-FR2 is not configured or the Serving Cell operates on FR1, this field may indicate whether power backoff is applied due to power management. The MAC entity may set the P field to 1 if the corresponding P_{CMAX,f,c} field would have had a different value if no power backoff due to the fact that power management had been applied; It should be noted that P-MPR may be the power backoff to meet the MPE FR2 requirement for a Serving Cell operation on FR2.
V: In some implementations, this field may indicate if the PH value for the corresponding TRP/SRS resource set/TCI state/panel/beam is based on a real transmission or a reference format. For Type-1 PH, the V field set to 0 indicates real transmission on PUSCH and the V field set to 1 indicates that a PUSCH reference format is used. In some implementations, this field may indicate if the PH value for both TRPs/SRS resource sets/TCI states/panel/beam are based on a real transmission or a reference format. For Type-1 PH, the V field set to 0 indicates real transmission on PUSCH and the V field set to 1 indicates that a PUSCH reference format is used;
P_{CMAX,f,c}: This field may indicate the P_{CMAX,f,c} used for calculation of the preceding PH field.
MPE: If mpe-Reporting-FR2 is configured, and the Serving Cell operates on FR2, and if the P field is set to 1, this field may indicate the applied power backoff to meet MPE requirements. In some implementations, for STxMP based PUSCH transmission, a Single Entry PHR MAC CE may include an MPE field, and an MPE value indicated in the MPE field may be an applied power backoff to meet MPE requirements for both PUSCH transmissions toward different TRPs in the STxMP operation. In some implementations, for STxMP based PUSCH transmission, a Single Entry PHR MAC CE may include two MPE fields, and two MPE values indicated in the two MPE fields may be two applied power backoffs to meet MPE requirements for two PUSCH transmissions toward two TRPs in the STxMP operation. It should be noted that two PUSCH transmissions toward two TRPs may be two PUSCH transmission associated with two SRS resource sets or two PUSCH transmission associated with two TCI states in a STxMP based PUSCH transmission.

In some implementations, if a UE is configured with twoPHRMode with the STxMP PUSCH transmission feature configured, the UE may report two PHs together with one P_{CMAX,f,c} for the Serving Cell, two PHs together with one P_{CMAX,f,c} for the SpCell of the other MAC entity, and/or two PHs together with one P_{CMAX,f,c} for the PCell. It should be noted that P_{CMAX,f,c} may be the UE configured maximum output power for carrier f of serving cell c. A PHR MAC CE may have a variable size, and may include bitmaps, two Type-2 PH fields and an octet containing the associated P_{CMAX,f,c} field (if reported) for SpCell of the other MAC entity, two Type-2 PH fields and an octet containing the associated P_{CMAX,f,c} field (if reported) for the PCell. The PHR MAC CE may further include, in ascending order based on the ServCellIndex, one or multiple of Type-X PH fields and octets containing the associated P_{CMAX,f,c} fields (if reported) for Serving Cells other than the PCell indicated in the bitmap for indicating the presence of PH(s), where X may be 1 or 3.

In some implementations, a PHR MAC CE may include at least one of the following fields:
Ci: The bitmap field. This field may indicate the presence of PH field(s) for the Serving Cell with ServCellIndex i. The Ci field set to 1 may indicate that PH field(s) for the Serving Cell with ServCellIndex i is reported. The Ci field set to 0 may indicate that PH field(s) for the Serving Cell with ServCellIndex i is not reported.
R: Reserved bits, set to 0;
P: If mpe-Reporting-FR2 is configured and the Serving Cell operates on FR2, the MAC entity may set this field to 0 if the applied P-MPR value is less than P-MPR_00 as specified in TS 38.133 and to 1 otherwise. If mpe-Reporting-FR2 is not configured or the Serving Cell operates on FR1, this field may indicate whether power backoff is applied due to power management. The MAC entity may set the P field to 1 if the corresponding P_{CMAX,f,c} field would have had a different value if no power backoff due to the fact that power management had been applied. It should be noted that P-MPR may be the power backoff to meet the MPE FR2 requirement for a Serving Cell operation on FR2.
Power Headroom (PH i): This field indicates the power headroom level, where a first PH may be associated with a first SRS resource set (e.g., SRS-ResourceSet with a lower srs-ResourceSetId), a first TCI state (e.g., the TCI state with a lower TCI state ID), a first beam, a first TRP, or a first panel, and a second PH may be associated with a second SRS resource set (e.g., the SRS-ResourceSet with a higher srs-ResourceSetId), a second TCI state (e.g., the TCI state with a higher TCI state ID), a second beam, a second TRP, or a second panel. PH fields for a Serving Cell may be included in ascending order based on i. The length of each PH field may be 6 bits.
V: In some implementations, this field may indicate if the PH value for the corresponding TRP/SRS resource set/TCI state/beam/panel is based on a real transmission or a reference format. For Type-1 PH, the V field set to 0 indicates real transmission on PUSCH and the V field set to 1 indicates that a PUSCH reference format is used. In some implementations, this field may indicate if the PH value for both TRPs/SRS resource sets/TCI states/beams/panels are based on a real transmission or a reference format. For Type-1 PH, the V field set to 0 indicates real transmission on PUSCH and the V field set to 1 indicates that a PUSCH reference format is used.
P_{CMAX,f,c}: This field may indicate the P_{CMAX,f,c} used for calculation of the preceding PH field.
MPE: If mpe-Reporting-FR2 is configured, and the Serving Cell operates on FR2, and if the P field is set to 1, this field may indicate the applied power backoff to meet MPE requirements. In some implementations, for STxMP based PUSCH transmission, a Single Entry PHR MAC CE may include an MPE field, and an MPE value indicated in the MPE field may be an applied power backoff to meet MPE requirements for both PUSCH transmissions toward different TRPs in STxMP operation. In some implementations, for STxMP based PUSCH transmission, a Single Entry PHR MAC CE may include two MPE fields, and two MPE values indicated in the two MPE fields may be two applied power backoffs to meet MPE requirements for two PUSCH transmissions toward two TRPs in STxMP operation. It should be noted that two PUSCH transmissions toward two TRPs may be two PUSCH transmission associated with two SRS resource sets or two PUSCH transmission associated with two TCI states in a STxMP based PUSCH transmission.

In some implementations, for STxMP based UL transmission (e.g., PUSCH transmission, PUCCH transmission and/or SRS transmission), a UE may receive, from a gNB/NW, a first RRC configuration corresponding to a first SRS resource set and a second RRC configuration corresponding to a second SRS resource set. The UE may transmit a first PUSCH toward a first TRP according to the first SRS resource set and may transmit a second PUSCH toward a second TRP according to the second SRS resource set. For CB based PUSCH transmission, the UE may determine a first transmission beam based one the first SRS resource set and a second transmission beam based on the second SRS resource set.

In some implementations, for STxMP based PUSCH transmission, a Single Entry PHR MAC CE may include a first PH field and a second PH field for a Serving Cell/PCell. In addition, the PHR MAC CE may include a first V field and a second V field to respectively indicate that the PH value in the first PH field and the PH value in the second PH field is based on a real transmission or a reference format. It should be noted that the first PH field may be associated with a first SRS resource set/TCI state/TRP/beam/panel and the second PH field may be associated with a second resource set/TCI state/TRP/beam/panel. For example, the PH value in the first PH field may be calculated based on the PUSCH transmission associated with a first SRS resource set/TCI state/TRP/beam/panel and the PH value in the second PH field may be calculated based on the PUSCH transmission associated with a second SRS resource set/TCI state/TRP/beam/panel.

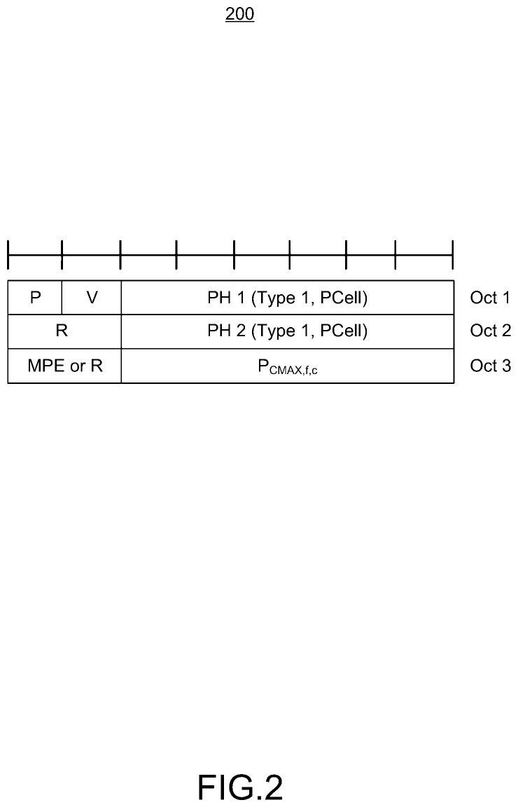

FIG. 2 illustrates a single entry PHR MAC CE 200 for the STxMP based PUSCH transmission according to an example implementation of the present disclosure. The PHR MAC CE 200 may include a first PH field and a second PH field for a Serving Cell/PCell. In addition, the PHR MAC CE 200 may include a V field to indicate that both PH values in the first PH field and the second PH field are based on a real transmission or a reference format. It should be noted that the first PH field may be associated with a first SRS resource set/TCI state/TRP/beam/panel and the second PH field may be associated with a second resource set/TCI state/TRP/beam/panel. For example, the PH value in the first PH field may be calculated based on the PUSCH transmission associated with a first SRS resource set/TCI state/TRP/beam/panel and the PH value in the second PH field may be calculated based on the PUSCH transmission associated with a second SRS resource set/TCI state/TRP/beam/panel. As illustrated in FIG. 2, the V field may be used to indicate whether both PH values in the PH 1 and PH 2 are based on real transmissions or reference formats. For Type-1 PH, the V field set to 0 may indicate both PH values in the PH 1 and PH 2 are based on real transmissions on PUSCHs associated with a first SRS resource set/TCI state/TRP/panel and a second SRS resource set/TCI state/TRP/panel. The V field set to 1 may indicate both PH values in the PH 1 and PH 2 are based on reference formats corresponding to PUSCH transmission associated with a first SRS resource set/TCI state/TRP/panel and a second SRS resource set/TCI state/TRP/panel.

It should be noted that FIG. 2 is an example for a Single Entry PHR MAC CE, e.g., including key fields. The detailed format of the Single Entry PHR MAC CE may not be limited to the PHR MAC CE 200 illustrated in FIG. 2.

In some implementations, for STxMP based PUSCH transmission, a Multiple Entry PHR MAC CE may include a first PH field and a second PH field for a Serving Cell/PCell/SpCell. In addition, the PHR MAC CE may include a first V field and a second V field, where the first V field indicates that the PH value in the first PH field is based on a real transmission or a reference format, and the second V field indicates that the PH value in the second field is based on a real transmission or a reference format. It should be noted that the first PH field may be associated with a first SRS resource set/TCI state/TRP/beam/panel and the second PH field may be associated with a second resource set/TCI state/TRP/beam/panel. For example, the PH value in the first PH field may be calculated based on the PUSCH transmission associated with a first SRS resource set/TCI state/TRP/beam/panel and the PH value in the second PH field may be calculated based on the PUSCH transmission associated with a second SRS resource set/TCI state/TRP/beam/panel.

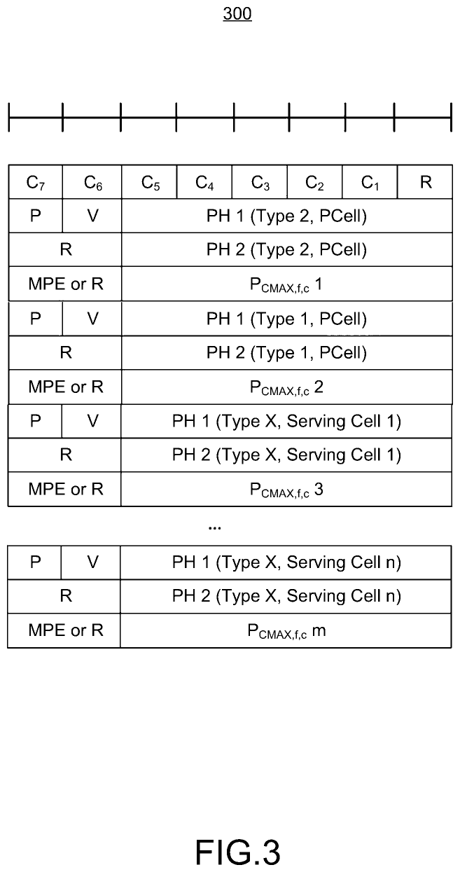

FIG. 3 illustrates a multiple entry PHR MAC CE 300 for the STxMP based PUSCH transmission according to an example implementation of the present disclosure. The Multiple Entry PHR MAC CE 300 may include a first PH field and a second PH field for a Serving Cell/PCell/SpCell. In addition, the PHR MAC CE 300 may include a V field to indicate that both PH values in the first PH field and the second PH field are based on a real transmission or a reference format. It should be noted that the first PH field may be associated with a first SRS resource set/TCI state/TRP/beam/panel and the second PH field may be associated with a second resource set/TCI state/TRP/beam/panel. For example, the PH value in the first PH field may be calculated based on the PUSCH transmission associated with a first SRS resource set/TCI state/TRP/beam/panel and the PH value in the second PH field may be calculated based on the PUSCH transmission associated with a second SRS resource set/TCI state/TRP/beam/panel. As illustrated in FIG. 3, the V field corresponding to a Cell (e.g., SpCell, PCell or Serving Cell) may be used to indicate if both PH values in the PH 1 and PH 2 associated with the Cell (e.g., SpCell, PCell or Serving Cell) are based on real transmissions or reference formats. For Type-1 PH, the V field set to 0 may indicate both PH values in the PH 1 and PH 2 are based on real transmissions on PUSCHs associated with a first SRS resource set/TCI state/TRP/panel and a second SRS resource set/TCI state/TRP/panel. The V field set to 1 may indicate both PH values in the PH 1 and PH 2 are based on reference formats corresponding to PUSCH transmission associated with a first SRS resource set/TCI state/TRP/panel and a second SRS resource set/TCI state/TRP/panel. For Type-2 PH, the V field set to 0 may indicate both PH values in the PH 1 and PH 2 are based on real transmissions on PUCCHs associated with a first SRS resource set/TCI state/TRP/panel and a second SRS resource set/TCI state/TRP/panel. The V field set to 1 may indicate both PH values in the PH 1 and PH 2 are based on reference formats corresponding to PUCCH transmission associated with a first SRS resource set/TCI state/TRP/panel and a second SRS resource set/TCI state/TRP/panel. For Type-3 PH, the V field set to 0 may indicate both PH values in the PH 1 and PH 2 are based on real transmissions on SRS associated with a first SRS resource set/TCI state/TRP/panel and a second SRS resource set/TCI state/TRP/panel. The V field set to 1 may indicate both PH values in the PH 1 and PH 2 are based on reference formats corresponding to SRS associated with a first SRS resource set/TCI state/TRP/panel and a second SRS resource set/TCI state/TRP/panel.

It should be noted that FIG. 3 is an example for a Multiple Entry PHR MAC CE, e.g., including key fields. The detailed format of the Multiple Entry PHR MAC CE may not be limited to the PHR MAC CE 300 illustrated in FIG. 3.

In some implementations, for STxMP based PUSCH transmission, a Single Entry PHR MAC CE may include a first PH field, a second PH field, a first P_{CMAX,f,c} field, and/or a second P_{CMAX,f,c} field for a Serving Cell/PCell. A first P_{CMAX,f,c} (e.g., P_{CMAX,f,c} 1) value in the first P_{CMAX,f,c} field may be used to calculate a first PH value in the first PH field by a UE and a second P_{CMAX,f,c} (e.g., P_{CMAX,f,c}2) value in the second P_{CMAX,f,c} field may be used to calculate a second PH value in the second PH field by the UE. In addition, the first PH value may be calculated based on a real transmission on a PUSCH associated with a first SRS resource set/TCI state/TRP/panel or a reference format corresponding to a PUSCH associated with a first SRS resource set/TCI state/TRP/panel by the UE. The second PH value may be calculated based on a real transmission on a PUSCH associated with a second SRS resource set/TCI state/TRP/panel or a reference format corresponding to a PUSCH associated with a second SRS resource set/TCI state/TRP/panel by the UE. For example, the first PH value may be calculated based on a first pathloss RS associated with the first indicated TCI state and the first maximum uplink transmit power (e.g., P_{CMAX,f,c}1), and the second PH value may be calculated based on a second pathloss RS associated with the second indicated TCI state and the second maximum uplink transmit power (e.g., P_{CMAX,f,c}2). It should be noted that the summation of 10^{(P}^{_{CMAX,f,c}}^{1)/10} and 10^{(P}^{_{CMAX,f,c}}^{2)/10} may be equal to or less than 10^{(P}^{_{CMAX,f,c}}^{)/10}, where P_{CMAX,f,c} may be the UE configured maximum output power for carrier f of serving cell c.

In some implementations, for STxMP based PUSCH transmission, a Multiple Entry PHR MAC CE may include a first PH field, a second PH field, a first P_{CMAX,f,c} field and/or a second P_{CMAX,f,c} field for a Serving Cell/PCell/SpCell. A first P_{CMAX,f,c} (e.g., P_{CMAX,f,c}1) value in the first P_{CMAX,f,c} field may be used to calculate a first PH value in the first PH field by a UE, and a second P_{CMAX,f,c} (e.g., P_{CMAX,f,c}2) value in the second P_{CMAX,f,c} field may be used to calculate a second PH value in the second PH field by the UE. In addition, the first PH value may be calculated based on a real transmission on a PUSCH associated with a first SRS resource set/TCI state/TRP/panel or a reference format corresponding to a PUSCH associated with a first SRS resource set/TCI state/TRP/panel by the UE. The second PH value may be calculated based on a real transmission on a PUSCH associated with a second SRS resource set/TCI state/TRP/panel or a reference format corresponding to a PUSCH associated with a second SRS resource set/TCI state/TRP/panel by the UE. It should be noted that the summation of 10^{(P}^{_{CMAX,f,c}}^{1)/10} and 10^{(P}^{_{CMAX,f,c}}^{2)/10} may be equal to or less than 10^{(P}^{_{CMAX,f,c}}^{)/10}, where P_{CMAX,f,c} may be the UE configured maximum output power for carrier f of serving cell c.

In some implementations, for STxMP based PUSCH transmission, a Single Entry PHR MAC CE or a Multiple Entry PHR MAC CE may include a first PH field, a second PH field, a P_{CMAX,f,c} field, and/or a delta field. A UE may calculate a first PH value based on a real transmission on a first PUSCH associated with a first SRS resource set/TCI state/TRP/panel or a reference format corresponding to the first PUSCH associated with a first SRS resource set/TCI state/TRP/panel. In addition, the first PH value may be calculated based on a first value P_{CMAX,f,c}1, where the first value P_{CMAX,f,c}1 value may be associated with a P_{CMAX,f,c} value and a delta value. A UE may calculate a second PH value based on a real transmission on a second PUSCH associated with a second SRS resource set/TCI state/TRP/panel or a reference format corresponding to the second PUSCH associated with a second SRS resource set/TCI state/TRP/panel. In addition, the second PH value may be calculated based on a second value P_{CMAX,f,c}2, where the second value P_{CMAX,f,c}2 value may be associated with a P_{CMAX,f,c} value and the delta value. In some implementations, the delta value Y indicated in the delta field may correspond to a ratio, e.g., 1/2, 1/3, 1/4. If the delta value indicated in the delta field is 1/2, the first value P_{CMAX,f,c}1 may be

$${P}_{CMAX , f , c} + 10 log ( \frac{1}{2} )$$

(e.g., P_{CMAX,f,c}+10 log(Y)) and the second value P_{CMAX,f,c}2 may be

$${P}_{CMAX , f , c} + 10 log ( \frac{1}{2} )$$

(e.g., P_{CMAX,f,c}+10 log(1−Y)). If the delta value indicated in the delta field is 1/3, in some implementations the first value P_{CMAX,f,c}1 may be

$${P}_{CMAX , f , c} + 10 log ( \frac{1}{3} )$$

(e.g., P_{CMAX,f,c}+10 log(Y)) and the second value P_{CMAX,f,c}2 may be

$${P}_{CMAX , f , c} + 10 log ( \frac{2}{3} ) ( e . g . ,$$

P_{CMAX,f,c}+10 log(1−Y)), and in some implementations the first value P_{CMAX,f}1 may be

$${P}_{CMAX , f , c} + 10 log ( \frac{2}{3} )$$

(e.g., P_{CMAX,f,c}+10 log(1−Y)) and the second value P_{CMAX,f,c}2 may be

$${P}_{CMAX , f , c} + 10 log ( \frac{1}{3} )$$

(e.g., P_{CMAX,f,c}+10 log(Y)). In some implementations, the length of the delta field may be 1 bit. ‘0’ may indicate the delta value x₁ and ‘1’ may indicate the delta value x₂, where x₁ and x₂ may be values of 1/z and Z may belong to predefined positive integers. For example, ‘0’ may indicate that the delta value is 1/2 and ‘1’ may indicate that the delta value is 1/4. 2 and 4 may be predefined. In some implementations, the length of the delta field may be 2 bits. ‘00’ may indicate the delta value x₁, ‘01’ may indicate the delta value x₂, ‘10’ may indicate the delta value x₃ and ‘11’ may indicate the delta value x₄ or ‘11’ is reserved, where x₁, x₂, x₃ and x₄ may be any values of 1/z and Z may belong to predefined positive integers. For example, ‘00’ may indicate that the delta value is 1/2, ‘01’ may indicate that the delta value is 1/3, ‘10’ may indicate that the delta value is 1/4 and ‘11’ may be reserved. The positive integers 2, 3 and 4 may be predefined.

In some implementations, for STxMP based PUSCH transmission, a Single Entry PHR MAC CE or a Multiple Entry PHR MAC CE may include a first PH field, a second PH field, a P_{CMAX,f,c} field, and/or a delta field. A UE may calculate a first PH value based on a real transmission on a first PUSCH associated with a first SRS resource set/TCI state/TRP/panel or a reference format corresponding to the first PUSCH associated with a first SRS resource set/TCI state/TRP/panel. In addition, the first PH value may be calculated based on a first value P_{CMAX,f,c}1, where the first value P_{CMAX,f,c}1 value may be associated with a P_{CMAX,f,c} value and a delta value. A UE may calculate a second PH value based on a real transmission on a second PUSCH associated with a second SRS resource set/TCI state/TRP/panel or a reference format corresponding to the second PUSCH associated with a second SRS resource set/TCI state/TRP/panel. In addition, the second PH value may be calculated based on a second value P_{CMAX,f,c}2, where the second value P_{CMAX,f,c}2 value may be associated with a P_{CMAX,f,c} value and the delta value. In some implementations, the delta value D may correspond to the ratio between P_{CMAX,f,c} 1 and P_{CMAX,f,c} 2

$$( e . g . , 10 log ( \frac{{P}_{CMAX , f , c} 1}{{P}_{CMAX , f , c} 2} ) or 10 log ( \frac{{P}_{CMAX , f , c} 2}{{P}_{CMAX , f , c} 1} ) ) .$$

### The P_{CMAX,f,c}1 may be

$$\frac{( {P}_{CMAX , f , c} 1 ) \cdot x}{x + 1} and {P}_{CMAX , f , c} 2 may be \frac{{P}_{CMAX , f , c} 2}{x + 1} , where x = {10}^{( \frac{D}{10} )} .$$

In some implementations, the length of the delta field may be 1 bit. ‘0’ may indicate the delta value D₁ and ‘1’ may indicate the delta value D₂, where D₁ and D₂ may belong to two predefined positive integers. For example, ‘0’ may indicate that the delta value D is 3 dB and ‘1’ may indicate the delta value 6 dB. 3 dB and 6 dB may be predefined.

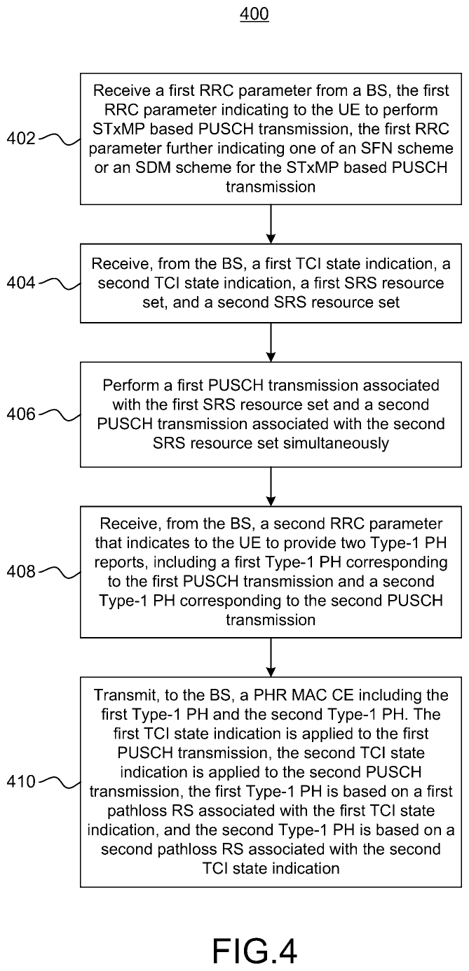

FIG. 4 is a flowchart 400 illustrating a method/process for STxMP operation performed by a UE, according to an example implementation of the present disclosure. In action 402, the UE may receive a first RRC parameter from a BS. The first RRC parameter may indicate to the UE to perform STxMP based PUSCH transmission. The first RRC parameter may further indicate one of an SFN scheme or an SDM scheme for the STxMP based PUSCH transmission.

In action 404, the UE may receive, from the BS, a first TCI state indication, a second TCI state indication, a first SRS resource set, and a second SRS resource set. The first TCI state indication and the second TCI state indication may be also referred to as the first indicated TCI state and the second indicated TCI state, respectively, in the present disclosure. The first SRS resource set and the second SRS resource set may be associated with a first TRP and a second TRP, respectively, where the first TRP and the second TRP may be associated with a serving cell of the BS.

In action 406, the UE may perform a first PUSCH transmission associated with the first SRS resource set and a second PUSCH transmission associated with the second SRS resource set simultaneously. An example is illustrated in FIG. 1, where the first PUSCH transmission and the second PUSCH transmission may take place on the same resource, thus a STxMP based PUSCH transmission.

In action 408, the UE may receive, from the BS, a second RRC parameter that indicates to the UE to provide two Type-1 PH reports, including a first Type-1 PH corresponding to the first PUSCH transmission and a second Type-1 PH corresponding to the second PUSCH transmission. For example, the second RRC parameter may be twoPHRMode.

In action 410, the UE may transmit, to the BS, a PHR MAC CE including the first Type-1 PH and the second Type-1 PH. The first SRS resource set and the second SRS resource set may be associated with a serving cell of the BS. The first TCI state indication may be applied to the first PUSCH transmission, and the second TCI state indication may be applied to the second PUSCH transmission. The first Type-1 PH may be based on a first pathloss RS associated with the first TCI state indication, and the second Type-1 PH may be based on a second pathloss RS associated with the second TCI state indication. An example of the PHR MAC CE may be referred to PHR MAC CE 106 illustrated in FIG. 1.

The technical problem addressed by the method illustrated in FIG. 4 is STxMP operation in a wireless communication system. Specifically, the method deals with the challenge of efficiently coordinating and managing the transmission of PUSCH data from a UE to a BS in the context of STxMP. This involves handling multiple TCI states, SRS resource sets, and PHRs associated with simultaneous PUSCH transmissions. The method provides an advantageous technical effect by enabling the UE to perform simultaneous PUSCH transmissions associated with different SRS resource sets. This allows for efficient utilization of resources, improved spectral efficiency, improved reliability, and shorter transmission latency. In particular, the use of multiple TCI indications for PUSCH transmission and corresponding Type-1 power headroom reports facilitates the coordination of simultaneous UL transmissions. The inclusion of specific pathloss reference signals associated with the TCIs further enhances the accuracy of power headroom reporting.

In some implementations, the PHR MAC CE may further include a first maximum uplink transmit power associated with the first PUSCH transmission and a second maximum uplink transmit power associated with the second PUSCH transmission. The first Type-1 PH may be further based on the first maximum uplink transmit power, and the second Type-1 PH may be further based on the second maximum uplink transmit power. For example, a first P_{CMAX,f,c} (e.g., P_{CMAX,f,c}1) value in the first P_{CMAX,f,c} field may be used to calculate a first PH value in the first PH field by a UE and a second P_{CMAX,f,c} (e.g., P_{CMAX,f,c}2) value in the second P_{CMAX,f,c} field may be used to calculate a second PH value in the second PH field by the UE.

In some implementations, the UE may receive a third RRC parameter that indicates a power change threshold for triggering PHR for the STxMP based PUSCH transmission. The power change threshold (e.g., phr-Tx-PowerFactorChange) may be associated with both the first PUSCH transmission and the second PUSCH transmission.

In some implementations, the PHR for the STxMP based PUSCH transmission may be triggered in a case that either a first path loss associated with the first PUSCH transmission or a second path loss associated with the PUSCH transmission has changed more than the power change threshold (e.g., phr-Tx-PowerFactorChange).

In some implementations, a first number of transmission layers associated with the first PUSCH transmission may be equal to a second number of transmission layers associated with the second PUSCH transmission in a case that the first RRC parameter indicates the SFN scheme for the STxMP based PUSCH transmission.

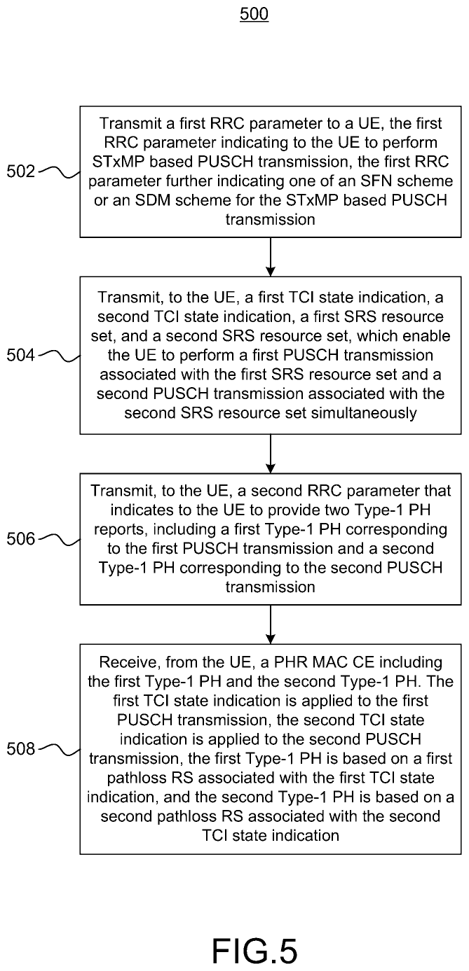

FIG. 5 is a flowchart 500 illustrating a method/process for STxMP operation performed by a BS, according to an example implementation of the present disclosure. In action 502, the BS may transmit a first RRC parameter to a UE. The first RRC parameter may indicate to the UE to perform STxMP based PUSCH transmission. The first RRC parameter may further indicate one of an SFN scheme or an SDM scheme for the STxMP based PUSCH transmission.

In action 504, the BS may transmit, to the UE, a first TCI state indication, a second TCI state indication, a first SRS resource set, and a second SRS resource set, which enable the UE to perform a first PUSCH transmission associated with the first SRS resource set and a second PUSCH transmission associated with the second SRS resource set simultaneously.

In action 506, the BS may transmit, to the UE, a second RRC parameter that indicates to the UE to provide two Type-1 PH reports, including a first Type-1 PH corresponding to the first PUSCH transmission and a second Type-1 PH corresponding to the second PUSCH transmission.

In action 508, the BS may receive, from the UE, a PHR MAC CE including the first Type-1 PH and the second Type-1 PH. The first TCI state indication may be applied to the first PUSCH transmission, and the second TCI state indication may be applied to the second PUSCH transmission. The first Type-1 PH may be based on a first pathloss RS associated with the first TCI state indication, and the second Type-1 PH may be based on a second pathloss RS associated with the second TCI state indication.

In some implementations, the PHR MAC CE may further include a first maximum uplink transmit power associated with the first PUSCH transmission and a second maximum uplink transmit power associated with the second PUSCH transmission. The first Type-1 PH may be further based on the first maximum uplink transmit power, and the second Type-1 PH may be further based on the second maximum uplink transmit power.

In some implementations, the BS may transmit a third RRC parameter that indicates a power change threshold for triggering PHR for the STxMP based PUSCH transmission. The power change threshold (e.g., phr-Tx-PowerFactorChange) may be associated with both the first PUSCH transmission and the second PUSCH transmission.

In some implementations, the PHR for the STxMP based PUSCH transmission may be triggered in a case that either a first path loss associated with the first PUSCH transmission or a second path loss associated with the PUSCH transmission has changed more than the power change threshold (e.g., phr-Tx-PowerFactorChange).

In some implementations, a first number of transmission layers associated with the first PUSCH transmission may be equal to a second number of transmission layers associated with the second PUSCH transmission in a case that the first RRC parameter indicates the SFN scheme for the STxMP based PUSCH transmission.

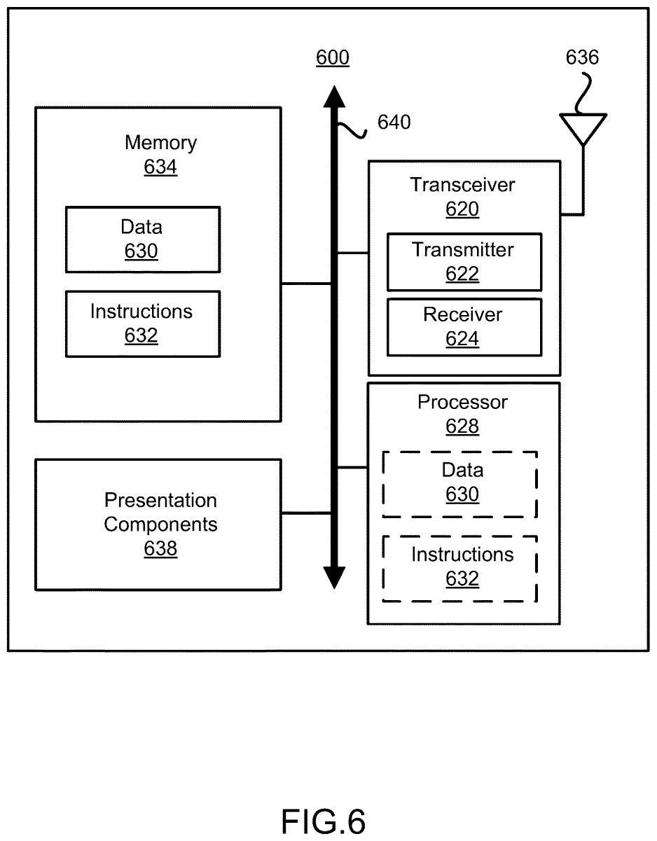

FIG. 6 is a block diagram illustrating a node 600 for wireless communication in accordance with various aspects of the present disclosure. As illustrated in FIG. 6, a node 600 may include a transceiver 620, a processor 628, a memory 634, one or more presentation components 638, and at least one antenna 636. The node 600 may also include a radio frequency (RF) spectrum band module, a BS communications module, a network communications module, and a system communications management module, Input/Output (I/O) ports, I/O components, and a power supply (not illustrated in FIG. 6).

Each of the components may directly or indirectly communicate with each other over one or more buses 640. The node 600 may be a UE or a BS that performs various functions disclosed with reference to FIGS. 1 through 5.

The transceiver 620 has a transmitter 622 (e.g., transmitting/transmission circuitry) and a receiver 624 (e.g., receiving/reception circuitry) and may be configured to transmit and/or receive time and/or frequency resource partitioning information. The transceiver 620 may be configured to transmit in different types of subframes and slots including, but not limited to, usable, non-usable, and flexibly usable subframes and slot formats. The transceiver 620 may be configured to receive data and control channels.

The node 600 may include a variety of computer-readable media. Computer-readable media may be any available media that may be accessed by the node 600 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 634 may include computer-storage media in the form of volatile and/or non-volatile memory. The memory 634 may be removable, non-removable, or a combination thereof. Example memory may include solid-state memory, hard drives, optical-disc drives, etc. As illustrated in FIG. 6, the memory 634 may store a computer-readable and/or computer-executable instructions 632 (e.g., software codes) that are configured to, when executed, cause the processor 628 to perform various functions disclosed herein, for example, with reference to FIGS. 1 through 5. Alternatively, the instructions 632 may not be directly executable by the processor 628 but may be configured to cause the node 600 (e.g., when compiled and executed) to perform various functions disclosed herein.

The processor 628 (e.g., having processing circuitry) may include an intelligent hardware device, e.g., a Central Processing Unit (CPU), a microcontroller, an ASIC, etc. The processor 628 may include memory. The processor 628 may process the data 630 and the instructions 632 received from the memory 634, and information transmitted and received via the transceiver 620, the baseband communications module, and/or the network communications module. The processor 628 may also process information to send to the transceiver 620 for transmission via the antenna 636 to the network communications module for transmission to a CN.

One or more presentation components 638 may present data indications to a person or another device. Examples of presentation components 638 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for simultaneous transmission with multi-panel (STxMP) operation, the method comprising:
receiving a first Radio Resource Control (RRC) parameter from a base station (BS), the first RRC parameter indicating to the UE to perform STxMP based physical uplink shared channel (PUSCH) transmission, the first RRC parameter further indicating one of a Single-Frequency Network (SFN) scheme or a Spatial Division Multiplexing (SDM) scheme for the STxMP based PUSCH transmission;
receiving, from the BS, a first Transmission Configuration Indication (TCI) state indication, a second TCI state indication, a first Sounding Reference Signal (SRS) resource set, and a second SRS resource set;
performing a first PUSCH transmission associated with the first SRS resource set and a second PUSCH transmission associated with the second SRS resource set simultaneously;
receiving, from the BS, a second RRC parameter that indicates to the UE to provide two Type-1 power headroom (PH) reports, including a first Type-1 PH corresponding to the first PUSCH transmission and a second Type-1 PH corresponding to the second PUSCH transmission; and
transmitting, to the BS, a power headroom report (PHR) medium access control (MAC) control element (CE) including the first Type-1 PH and the second Type-1 PH,
wherein:
the first SRS resource set and the second SRS resource set are associated with a serving cell of the BS,
the first TCI state indication is applied to the first PUSCH transmission,
the second TCI state indication is applied to the second PUSCH transmission,
the first Type-1 PH is based on a first pathloss reference signal (RS) associated with the first TCI state indication, and
the second Type-1 PH is based on a second pathloss RS associated with the second TCI state indication.

2. The method of claim 1, wherein:
the PHR MAC CE further includes a first maximum uplink transmit power associated with the first PUSCH transmission and a second maximum uplink transmit power associated with the second PUSCH transmission,
the first Type-1 PH is further based on the first maximum uplink transmit power, and
the second Type-1 PH is further based on the second maximum uplink transmit power.

3. The method of claim 1, further comprising:
receiving a third RRC parameter that indicates a power change threshold for triggering PHR for the STxMP based PUSCH transmission, the power change threshold being associated with both the first PUSCH transmission and the second PUSCH transmission.

4. The method of claim 3, wherein the PHR for the STxMP based PUSCH transmission is triggered in a case that either a first path loss associated with the first PUSCH transmission or a second path loss associated with the PUSCH transmission has changed more than the power change threshold.

5. The method of claim 1, wherein a first number of transmission layers associated with the first PUSCH transmission is equal to a second number of transmission layers associated with the second PUSCH transmission in a case that the first RRC parameter indicates the SFN scheme for the STxMP based PUSCH transmission.

6. A user equipment (UE) for simultaneous transmission with multi-panel (STxMP) operation, the UE comprising:
one or more processors; and
at least one memory coupled to at least one of the one or more processors, the at least one memory storing computer-executable instructions that, when executed by the at least one of the one or more processors, cause the UE to:
receive a first Radio Resource Control (RRC) parameter from a base station (BS), the first RRC parameter indicating to the UE to perform STxMP based physical uplink shared channel (PUSCH) transmission, the first RRC parameter further indicating one of a Single-Frequency Network (SFN) scheme or a Spatial Division Multiplexing (SDM) scheme for the STxMP based PUSCH transmission;
receive, from the BS, a first Transmission Configuration Indication (TCI) state indication, a second TCI state indication, a first Sounding Reference Signal (SRS) resource set, and a second SRS resource set;
perform a first PUSCH transmission associated with the first SRS resource set and a second PUSCH transmission associated with the second SRS resource set simultaneously;
receive, from the BS, a second RRC parameter that indicates to the UE to provide two Type-1 power headroom (PH) reports, including a first Type-1 PH corresponding to the first PUSCH transmission and a second Type-1 PH corresponding to the second PUSCH transmission; and
transmit, to the BS, a power headroom report (PHR) medium access control (MAC) control element (CE) including the first Type-1 PH and the second Type-1 PH,
wherein:
the first SRS resource set and the second SRS resource set are associated with a serving cell of the BS,
the first TCI state indication is applied to the first PUSCH transmission,
the second TCI state indication is applied to the second PUSCH transmission,
the first Type-1 PH is based on a first pathloss reference signal (RS) associated with the first TCI state indication, and
the second Type-1 PH is based on a second pathloss RS associated with the second TCI state indication.

7. The UE of claim 6, wherein:
the PHR MAC CE further includes a first maximum uplink transmit power associated with the first PUSCH transmission and a second maximum uplink transmit power associated with the second PUSCH transmission,
the first Type-1 PH is further based on the first maximum uplink transmit power, and
the second Type-1 PH is further based on the second maximum uplink transmit power.

8. The UE of claim 6, wherein the computer-executable instructions, when executed by the at least one of the one or more processors, further cause the UE to:
receive a third RRC parameter that indicates a power change threshold for triggering PHR for the STxMP based PUSCH transmission, the power change threshold being associated with both the first PUSCH transmission and the second PUSCH transmission.

9. The UE of claim 8, wherein the PHR for the STxMP based PUSCH transmission is triggered in a case that either a first path loss associated with the first PUSCH transmission or a second path loss associated with the PUSCH transmission has changed more than the power change threshold.

10. The UE of claim 6, wherein a first number of transmission layers associated with the first PUSCH transmission is equal to a second number of transmission layers associated with the second PUSCH transmission in a case that the first RRC parameter indicates the SFN scheme for the STxMP based PUSCH transmission.

11. A base station (BS) for configuring simultaneous transmission with multi-panel (STxMP) operation, the BS comprising:
one or more processors; and
at least one memory coupled to at least one of the one or more processors, the at least one memory storing computer-executable instructions that, when executed by the at least one of the one or more processors, cause the BS to:
transmit a first Radio Resource Control (RRC) parameter to a user equipment (UE), the first RRC parameter indicating to the UE to perform STxMP based physical uplink shared channel (PUSCH) transmission, the first RRC parameter further indicating one of a Single-Frequency Network (SFN) scheme or a Spatial Division Multiplexing (SDM) scheme for the STxMP based PUSCH transmission;
transmit, to the UE, a first Transmission Configuration Indication (TCI) state indication, a second TCI state indication, a first Sounding Reference Signal (SRS) resource set, and a second SRS resource set, which enable the UE to perform a first PUSCH transmission associated with the first SRS resource set and a second PUSCH transmission associated with the second SRS resource set simultaneously;
transmit, to the UE, a second RRC parameter that indicates to the UE to provide two Type-1 power headroom (PH) reports, including a first Type-1 PH corresponding to the first PUSCH transmission and a second Type-1 PH corresponding to the second PUSCH transmission; and
receive, from the UE, a power headroom report (PHR) medium access control (MAC) control element (CE) including the first Type-1 PH and the second Type-1 PH,
wherein:
the first SRS resource set and the second SRS resource set are associated with a serving cell of the BS,
the first TCI state indication is applied to the first PUSCH transmission,
the second TCI state indication is applied to the second PUSCH transmission,
the first Type-1 PH is based on a first pathloss reference signal (RS) associated with the first TCI state indication, and
the second Type-1 PH is based on a second pathloss RS associated with the second TCI state indication.

12. The BS of claim 11, wherein:
the PHR MAC CE further includes a first maximum uplink transmit power associated with the first PUSCH transmission and a second maximum uplink transmit power associated with the second PUSCH transmission,
the first Type-1 PH is further based on the first maximum uplink transmit power, and
the second Type-1 PH is further based on the second maximum uplink transmit power.

13. The BS of claim 11, wherein the computer-executable instructions, when executed by the at least one of the one or more processors, further cause the BS to:
transmit a third RRC parameter that indicates a power change threshold for triggering PHR for the STxMP based PUSCH transmission, the power change threshold being associated with both the first PUSCH transmission and the second PUSCH transmission.

14. The BS of claim 13, wherein the PHR for the STxMP based PUSCH transmission is triggered in a case that either a first path loss associated with the first PUSCH transmission or a second path loss associated with the PUSCH transmission has changed more than the power change threshold.

15. The BS of claim 11, wherein a first number of transmission layers associated with the first PUSCH transmission is equal to a second number of transmission layers associated with the second PUSCH transmission in a case that the first RRC parameter indicates the SFN scheme for the STxMP based PUSCH transmission.
